(19) United States
(12) Patent Application Publication
(10) Pub. No.: US 2025/0287871 A1
(43) Pub. Date: Sep. 18, 2025

(54) GRAIN LOSS DETECTORS FOR A COMBINE HARVESTER

(71) Applicant: Bushel Plus Ltd., Brandon (CA)

(72) Inventor: Marcel Kringe, Brandon (CA)

(21) Appl. No.: 19/052,573

(22) Filed: Feb. 13, 2025

Related U.S. Application Data
(60) Provisional application No. 63/398,108, filed on Aug. 15, 2022.

(30) Foreign Application Priority Data
Aug. 15, 2023 (WO) PCT/CA2023/051082

(51) Int. Cl. A01D 41/127

(52) U.S. Cl. CPC A01D 41/1273; A01D 41/1276

(57) ABSTRACT

A grain loss detector disposed on a combine harvester to detect grain loss within crop material being discharged by a separating or cleaning stage component of combine harvester while harvesting a crop. The grain loss detector includes at sensor generating sensor data output. A computing device receives the sensor data output for processing via software which compares the sensor data output against crop data characteristics to identify any grain kernels from among material other than grain. In one embodiment the sensor is a camera and the generated sensor data output is a digital image frame capturing the grain kernels and material other than grain passing the camera.

### BACKGROUND

Agricultural combine harvesters (“combines” for short) are used in the harvesting of crops. The term “combine” derives from the multiple functions that are combined within a single harvesting machine, including the cutting of the crop, threshing of the cut crop, separating the grain from the unwanted crop material, and cleaning the grain.

A “header” is a removable attachment that mounts on the front of the combine. Different types of headers are used for harvesting different types of crops. For example, a corn header is mounted on the combine for harvesting corn. Draper headers and auger headers are used for harvesting small grains, such as wheat, oats, barley, soybeans, canola, etc. Pickup headers are used for picking up crops that have been previously cut and windrowed. Depending on the type of header and crop being harvested, the header will cut or strip the standing crop or will pick up the windrows as the combine advances through the field. The header feeds the crop material into the combine for threshing and separating the grain kernels from the unwanted crop material (i.e., husks, cobs, straw, chaff, etc.). The unwanted crop material is discharged from the rear of the combine onto the field and the grain kernels are held in a hopper while the combine continues to harvest the crop until the clean grain is offloaded to a grain cart or other transport vehicle.

During harvesting operations, grain loss can occur due to improper settings of the header and the various components that perform the threshing, separating and cleaning processes, all of which are influenced by various factors including ground speed of the combine, moisture or dryness of the crop, moisture of the grain, weather conditions, wear of parts, mechanical failures, operator error and other factors. Small changes to the operating parameters of the combine can dramatically increase grain losses or dramatically reduce grain losses. Thus if the operating parameters of the header or the operating parameters of the various components of the combine that perform the threshing, separating and cleaning processes are not optimized for the crop conditions, weather conditions, etc., thousands of dollars' worth of grain loss can occur.

For example, assume an operator is harvesting 1000 acres of wheat with an average yield of fifty bushels per acre. In 2021, the average price of wheat was around $7.00 per bushel. If it was possible to operate the combine with zero grain loss (which is never possible), the 1000 acres would produce 50,000 bushels of wheat worth $350,000 or $350.00 per acre. It is not uncommon for grain losses to exceed ten percent (10%) during harvesting operations. At a 10% grain loss, using the assumptions above, the operator will have lost 5,000 bushels or $35,000 worth of wheat over the 1000 acres, which equates to five bushels per acre or $35.00 per acre of losses. Many operators consider a grain loss of two bushels per acre (i.e., 4% grain loss, assuming fifty bushels per acre) to be acceptable. Even at the generally acceptable loss of two bushel per acre, the operator is still losing 2,000 bushels or $14,000 worth of wheat over the 1000 acres, or $14.00 per acre. If the operator is able to reduce the grain loss to a ½ bushel per acre (i.e., 1% grain loss, assuming fifty bushels per acre), the operator will lose only 500 bushels or $3,500 worth of wheat over the 1000 acres, or $3.50 per acre. Put another way, by reducing grain loss from 4% to 1% per acre, the producer will have gained 1,500 bushels or $10,500 worth of wheat over the 1000 acres, which equates to a gain of $10.50 per acre. In the United States alone, in 2021, over 40 million acres of small grain (wheat, barley, oats, rye) were harvested, over 85 million acres of corn harvested and over 82 million acres of soybeans harvested. Accordingly, it should be appreciated that even a 1% decrease in grain loss could equate to billions of dollars in additional revenue, annually to the nation's crop growers.

Many late model combines are now designed with various sensors that can detect grain loss and monitor the quality of the cleaned grain. Based on the feedback from these sensors and monitors, the settings of the various threshing, separating and cleaning functions are automatically adjusted to optimize the performance of the combine to minimize grain loss and improve cleaned grain quality. Most growers or operators, however, continue to run older combine models that do not have all of the sensors and monitors now found in the latest combine models. Additionally, even with the latest combine models, it is still desirable to have a separate system that can double check the accuracy of the existing grain loss sensors and to calibrate the existing grain loss sensors.

Accordingly, there remains a need for an accurate grain loss detection system that can be installed at different locations within the combine to determine grain losses at the different areas of the combine so appropriate adjustments can be made to the threshing, separating and cleaning components to optimize the performance of the combine and reduce grain loss. Ideally such a system would be cost effective and readily installed with minimal or no modification to the combine's components or systems.

### BRIEF DESCRIPTION OF THE DRAWINGS

FIG. 1 is a side elevation view of an example of one type of combine shown in partial cutaway to illustrating an axial rotor and showing how the crop material may flow through such a combine from the header, to the feeder house, and through the threshing, separating and cleaning components and the residue discharge area.

FIG. 1A is an enlarged partial view of FIG. 1.

FIG. 2 is a side elevation view of an example of another type of combine shown in partial cutaway illustrating a transverse rotor with straw walkers and showing how the crop material may flow through such a combine from the header, to the feeder house, and through the threshing, separating and cleaning components and the residue discharge area.

FIG. 2A is an enlarged partial view of FIG. 2.

FIG. 3 is a side elevation view of an example of another type of combine shown in partial cutaway to illustrate another type of transverse rotor and showing how the crop material may flow through such a combine from the header, to the feeder house, and through the threshing, separating and cleaning components and the residue discharge area.

FIG. 3A is an enlarged partial view of FIG. 3.

FIG. 4 is a further enlarged partial view of FIG. 1A with the crop material and identifying locations where crop material may be collected for analysis by a grain loss detector.

FIG. 5 is a further enlarged partial view of FIG. 2A with the crop material and identifying locations where crop material may be collected for analysis by a grain loss detector.

FIG. 6 is a further enlarged partial view of FIG. 3A with the crop material and identifying locations where crop material may be collected for analysis by a grain loss detector.

FIG. 7 is a general representation of an embodiment of grain loss detector.

FIG. 8 is an illustration of another embodiment of a grain loss detector for collecting crop material from the separating concaves.

FIGS. 9A-9C illustrate different embodiments of a grain loss detector adapted for collecting crop material at the rearward end of the upper sieve.

FIG. 10 is a partial side elevation view of a combine showing the grain loss detector positioned rearward of the upper sieve and disposed to receive crop material discharged from the upper sieve.

FIGS. 11A-11C illustrate different embodiments of a grain loss detector adapted for collecting crop material at the rearward end of the straw walker.

FIG. 12 is a partial side elevation view of a combine showing the grain loss detector positioned rearward of the straw walker and disposed to receive crop material discharged from the straw walker.

FIG. 13A is a rearward perspective view showing of a portion of a cleaning shoe with a prior art sieve loss sensor disposed in a rear pan.

FIG. 13B is another rearward perspective view of a portion of a cleaning shoe similar to FIG. 13A, but showing a different prior art sieve loss sensor mounted to a rear pan.

FIG. 14A is an enlarged rearward perspective view of a portion of the cleaning shoe illustrating another embodiment of a grain loss detector disposed below an opening in a rear pan.

FIG. 14B is a partial cross-sectional view of the grain loss detector of FIG. 14A as viewed along lines B-B of FIG. 14A.

FIG. 15A is a perspective view of another embodiment of a grain loss detector comprising a ring disposed below the discharge plate and openings after removal of the OEM sensors.

FIG. 15B is a partial cross-sectional view of the grain loss detector of FIG. 15A as viewed along lines B-B of FIG. 15A.

FIG. 15C is a perspective view of the grain loss detector of FIG. 15A.

FIG. 15D is a top plan of the grain loss detector of FIG. 15A with the top plate removed.

FIG. 16A is a perspective view of another embodiment of a grain loss detector comprising a cameras below the disposed below the discharge plate and openings after removal of the OEM sensors and including a slide plate.

FIG. 16B is a partial cross-sectional view of the grain loss detector of FIG. 16A as viewed along lines B-B of FIG. 16A.

FIG. 17A is a perspective view of another embodiment of a grain loss detector comprising one or more cameras disposed below the discharge plate and below a transparent window after removal of the OEM sensor.

FIG. 17B is a partial cross-sectional view of the grain loss detector of FIG. 17A as viewed along lines B-B of FIG. 17A.

FIG. 18A is a perspective view of another embodiment of a grain loss detector comprising a plurality of cameras disposed below an enlarged transparent window across substantially the width of the discharge plate.

FIG. 18B is a partial cross-sectional view of the grain loss detector of FIG. 18A as viewed along lines B-B of FIG. 18A.

FIG. 19A is a perspective view of another embodiment of a grain loss detector comprising a plurality of cameras disposed above the discharge plate and rearward of the sieves.

FIG. 19B is a partial cross-sectional view of the grain loss detector of FIG. 19A as viewed along lines B-B of FIG. 19A.

FIG. 20A is a perspective view of another embodiment of a grain loss detector comprising a camera disposed above the discharge plate and with a field of view toward the sieves.

FIG. 20B is a partial cross-sectional view of the grain loss detector of FIG. 20A as viewed along lines B-B of FIG. 20A.

FIG. 21 is a schematic illustration of a grain loss detector system.

### DESCRIPTION

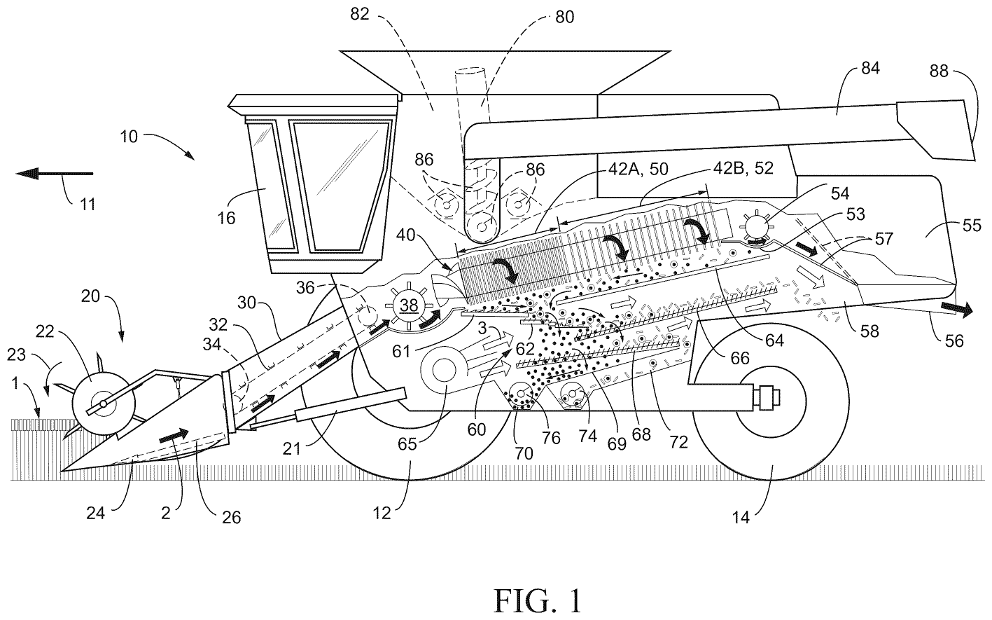

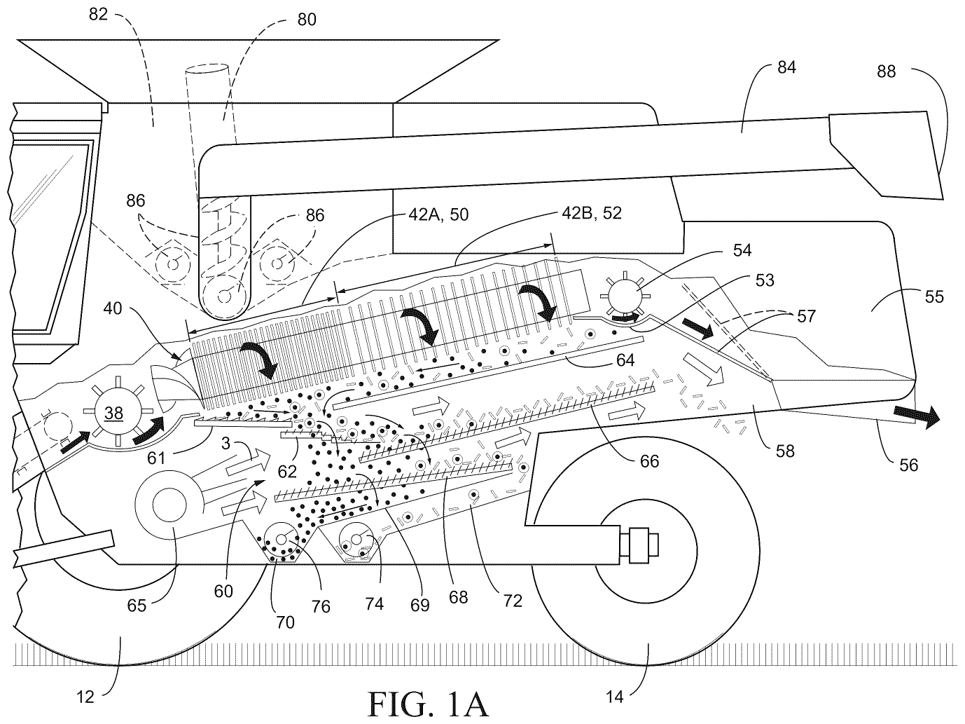

Referring now to the drawings, wherein like reference numbers designate the same or corresponding parts throughout the several figures, FIGS. 1, 2 and 3 are side elevation views of examples of different types of combines shown in partial cutaway. The differences between the different types of combines will be discussed later. In each of the examples, the combine 10 is shown as having front drive wheels 12 and steerable rear wheels 14. Instead of front wheels, the combine 10 may include tracks (not shown). An operator cab 16 is positioned at the front of the combine 10.

In FIGS. 1, 2 and 3, the combine 10 is shown harvesting a standing crop 1, such as wheat, and each illustrates how the crop material may flow through each of the respective types of combine examples. In FIG. 1, the header 20, is depicted as a draper header, mounted to the front of the combine 10. The header 20 may be raised and lowered vertically with respect to the combine 10 and the ground surface by hydraulic cylinders 21. The header 20 may also be tilted fore and aft and tilted laterally from side to side by other hydraulic cylinders (not shown). The draper header 20 includes a reel 22, a cutter bar 24 and conveyors 26. The reel 22 rotates in the direction indicated by arrow 23. As the combine 10 advances through the field in a forward direction of travel designated by arrow 11, the cutter bar 24 cuts the standing crop 1. The rotating reel 22 pulls the cut crop into the header 20. The crop material 2, indicated by solid black arrows, is conveyed by the conveyors 26 toward the middle of the header 20. The header 20 feeds the cut crop into the combine's feeder house 30.

While the foregoing describes the structure and operation of a draper header, the same general principles apply to other types of headers used for harvesting other types of crops. For example, instead of a draper header, the header 20 may be an auger header which includes a similar reel 22 and cutter bar 24 as the draper header, but instead of a conveyer 26 the auger header utilizes a transverse auger to move the crop material 2 toward the middle of the header and into the combine's feeder house 30. Alternatively, instead of a draper header or auger header which utilize a cutter bar and reel to cut the standing crop and feed it into the header, the header may be a row crop header, such as corn header. With a corn header, crop dividers or snouts extend between crop rows. Instead of a cutter bar, the corn header utilizes stalk rolls and stripper plates to strip the corn ears from the corn stalks and instead of a reel to pull the crop into the header, a corn head uses gathering chains to pull the stripped corn ears into a cross-auger which moves the stripped ears toward the middle of the header and into the combine's feeder house. In yet another alternative embodiment, instead of a draper header, auger header or row-crop header, the header may be a pickup header that that picks up a previously cut and windrowed crop and which feeds the windrows into the combine's feeder house. Those of ordinary skill in the art of combines and headers would understand and recognize each of these different types of headers and therefore illustration and further discussion of the different types of headers are not necessary. It should be appreciated, therefore, that regardless of the type of header 20, the header 20 performs the general function of collecting the crop as the combine 10 advances in the forward direction of travel 11, (whether by cutting, stripping or picking up the crop), and feeds the collected crop material into the combine's feeder house 30, whether by conveyors, cross augers or other structure as recognized and understood by those of ordinary skill in the art.

The internal components of the combine 10 which perform the threshing, separating and cleaning processes are hereinafter described in connection with each of the examples of different styles or types combines illustrated in FIGS. 1, 2 and 3. It should be understood that components and the configuration and placement of the components may vary between the various makes and models of each of the different types of combines described and illustrated by way of example in FIGS. 1, 2 and 3. Accordingly, it should be understood that the drawings referenced herein and the following description are intended to provide non-limiting examples of the different styles or types of components and the configuration or arrangement of those components for performing the threshing, separating and cleaning processes within a combine.

### Axial Rotor Combines

Referring to FIGS. 1 and 1A, the crop material from the header 20, enters the feeder house 30. The feeder house 30 typically includes a feeder house chain or belt 32 extending around a forward drum 34 and rearward drum 36. The feeder house chain or belt 30 feeds the crop material to a rotating feed accelerator drum 38 which pulls the crop material toward a rotor 40. In FIGS. 1 and 1A, the rotor 40 is shown as an axial rotor, in that it is disposed axially or in the longitudinal direction of the combine 10 and rotates around its axial or longitudinal axis. In some embodiments, a pair of parallel axial rotors are utilized instead of one axial rotor.

Concaves 42 surround or partially surround the rotor 40. As best illustrated in the perspective view of FIG. 8, the concaves 42 are comprised of concave segments 44 with each segment comprised of a series of spaced curved bars 46 defining narrow slots 48 between the bars 46. The concave segments 44 are received within guide rails (not shown) spaced axially along the length of the rotor 40. The concave segments 44 are received within the guide rails end-to-end to form a circular or partially circular cage surrounding or partially surrounding the circumference of the rotating rotor 40 in radially outward spaced relation from the outwardly projecting fingers or beaters (not shown) extending from the rotor 40. The guide rails receiving the concave segments 44 may be adjustable to vary the radially outward spacing of the concave segments 44 with respect to the outer circumference of the rotor 40. Different concaves 42 with different bar widths, different bar spacings and different width slots are used for different types of crops and different crop conditions. Thus, growers/operators will typically have several sets of concaves 42 that are interchangeably inserted into the guide rails depending on the crop being harvested and crop conditions.

As best shown in FIG. 1A, threshing concaves 42A are disposed along a first length of the rotor 40 defining the threshing zone 50. Separating concaves 42B are disposed along a second length of the rotor 40 defining a separating zone 52. The threshing concaves 42A will typically have wider bars 46 or more closely spaced bars 46 and narrower width slots 48. The separating concaves 42B will typically have narrower bars 46 or wider spaced bars 46 and wider slots 48. Thus, it should be appreciated that as the rotor 40 rotates, the crop material 2 is raked over and along the threshing concaves 42A along the threshing zone 50 to dislodge the grain kernels from the unwanted crop material. The threshed crop material then passes from the threshing zone 50 into the separating zone 52 where the threshed crop material is raked over the separating concaves 42B to separate the grain kernels from the unwanted crop material. The separated grain kernels and smaller pieces of crop material fall by gravity through the slots 48.

In FIG. 1A, the separated grain kernels are represented by solid black dots. Circled black dots are intended to represent unwanted crop material with attached grain kernels hereinafter referred to as “tailings.” Small open rectangles are intended to represent small pieces of unwanted crop material without any attached grain kernels, hereinafter referred to as “chaff”. The separated grain kernels, tailings and chaff are shown falling by gravity through the slots 48 of the concaves 42A, 42B along the threshing zone 50 and separating zone 52 of the rotor 40. The remaining unwanted crop material that does not fall through the slots 48 of the concaves 42 (e.g., straw, leaves, stalks, stems, husks, cobs, etc., depending on the crop being harvested), hereinafter referred to as “residue”, is discharged from the end of the rotor 40. The residue may pass under a beater drum 54 rotating above a slotted beater pan 53 after exiting the rotor 40 to remove any remaining grain kernels that may remain in the residue. The beater drum 54 directs the residue to the rear discharge area 55 of the combine 10. A deflector door 57 may be selectively positionable to direct the residue from the rotor 40 or beater drum 54 into a residue chopper 56 located in the rear discharge area 55 of the combine. The residue chopper 56 includes chopping blades or knives to chop and spread the residue outwardly behind the combine 10. Alternatively, the deflector door 57 may be positioned as shown in dashed lines to direct the residue from the rotor 40 or beater drum 54 downwardly to a discharge opening 58 in the rear discharge area 55 of the combine so the residue does not pass through the residue chopper 56 and falls downwardly to the ground surface in rows behind the combine 10.

The separated grain kernels, tailings and chaff passing through the slots 48 of the threshing concaves 42A and separating concaves 42B fall by gravity into the oscillating cleaning assembly commonly referred to as the cleaning shoe 60. The cleaning shoe 60 may include a forward pan 61, a pre-sieve 62, an upper sieve 66, and a lower sieve 68. The grain kernels that pass through the threshing concaves 42A fall onto the oscillating forward pan 61 disposed below the forward length of the rotor 40. The forward pan 61 may include a series of ridges which cooperate with the oscillating action of the forward pan 61 to walk the separated grain kernels, tailings and chaff rearwardly toward a pre-sieve 62. The separated grain kernels, tailings and chaff passing through the slots 48 of the separating concaves 42B at the rearward end of the rotor 40 and passing through the beater pan 53 fall onto an oscillating return pan 64 disposed below the rearward length of the rotor 40. The oscillating action of the return pan 64 moves the separated grain kernels, tailings and chaff forwardly and downwardly as indicated by line arrows toward the forward pan 61 and the pre-sieve 62.

A blower 65 is positioned below the forward pan 61. The blower 65 produces rearwardly directed air streams designated by unfilled arrows 3.

The pre-sieve 62 includes a series of louvers which can be adjustably positioned by an actuator to open and close. The smaller, heavier separated grain kernels pass through openings between the louvers by gravity, but ideally, the louvers prevent the larger pieces of chaff and tailings from passing through the openings between the louvers. Ideally, most of the smaller, lighter chaff on the pre-sieve 62 is blown rearwardly by the air streams 3 passing through the openings between the louvers which carry the lighter chaff toward the upper-sieve 66, also commonly referred to as a “chaffer”.

The upper sieve or chaffer 66 includes a series of louvers which can be adjustably positioned by an actuator to open and close. The smaller, heavier separated grain kernels pass through openings between the louvers by gravity, but ideally the louvers prevent the larger pieces of chaff and tailings from passing through the openings between the louvers. Ideally, most of the smaller, lighter chaff on the upper sieve 66 is blown rearwardly by the air streams 3 passing over the upper sieve and upward through the openings between the louvers which carry the lighter chaff to the discharge opening 58. The heavier tailings and chaff which are unable to pass through the openings between the louvers continue to be agitated by the oscillating action of the upper sieve 66 so as to ideally dislodge any remaining grain kernels from the tailings and to clean the separated grain kernels from the chaff. The oscillating action of the upper sieve 66 in combination with the louvers also walks the larger chaff, but ideally not the tailings, rearwardly toward the discharge opening 58.

The separated grain kernels and any small tailings and chaff that pass through the openings between the adjustable louvers of the upper sieve 66 drop by gravity onto the oscillating lower sieve 68 disposed below the upper sieve 66. The lower sieve 68 is inclined upwardly from its forward to its rearward end. The lower sieve 68 also includes a series of louvers which can be adjustably positioned by an actuator to open and close. The smaller, heavier separated grain kernels pass through openings between the louvers by gravity, but ideally the position of the louvers prevent the larger pieces of chaff and tailings from passing through the openings between the louvers. The small, heavier separated grain kernels passing through the openings between the louvers fall onto a clean grain pan 69 disposed below the lower sieve 68. The clean grain pan 69 directs the cleaned grain kernels to a clean grain trough 70.

It should be appreciated that the louver positions of the pre-sieve 62, the upper sieve 66 and the lower sieve 68 are adjusted depending on various factors, including the crop being harvested, the crop conditions, weather conditions, the amount of tailings and chaff on the respective sieves 62, 66, 68, the air speed or air volume from the blower 65, and various other factors.

Most of the chaff remaining on the lower sieve 68 will ideally be blown rearwardly by the air stream 3 out the discharge opening 58. Any tailings that are too large to fall through the openings between the louvers and which are too heavy to be blown by the air stream 3 to the discharge opening 58 are walked rearwardly by the oscillating action of the lower sieve 68 where the tailings drop into the tailings chute 72. A tailings auger 74 is disposed in the bottom of the tailings chute 72. The tailings auger 74 moves the tailings to a tailings elevator (not shown). The tailings elevator returns the tailings to the separating zone 52 of the rotor 40 for recycling through the separating and cleaning stages as described above to ideally ensure that all the grain kernels from the recycled tailings are separated and captured in the clean grain trough 70.

The separated grain kernels that have collected in the clean grain trough 70 are moved by a clean grain auger 76 disposed in a bottom of the clean grain trough 70 to a clean grain elevator (not shown). The clean grain elevator lifts the clean grain kernels upwardly toward a grain tank auger 80. The grain tank auger 80 augers the clean grain kernels into the grain tank 82. The clean grain remains in the grain tank 82 until the clean grain is offloaded to a grain cart or other transport vehicle (not shown) via an unload auger 84. The unload auger 84 swings outwardly from its storage position (shown in FIG. 1) to the unload position (not shown) which is substantially perpendicular to the forward direction of travel 11 of the combine 10. The grain tank 82 includes bottom augers 86 to help move the clean grain to the unload auger 84. The unload auger 84 discharges the clean grain into a grain cart or other transport vehicle positioned below the auger spout 88 of the outwardly extended unload auger 84.

### Combines With Transverse Threshing and Separating Rotors and Straw Walkers

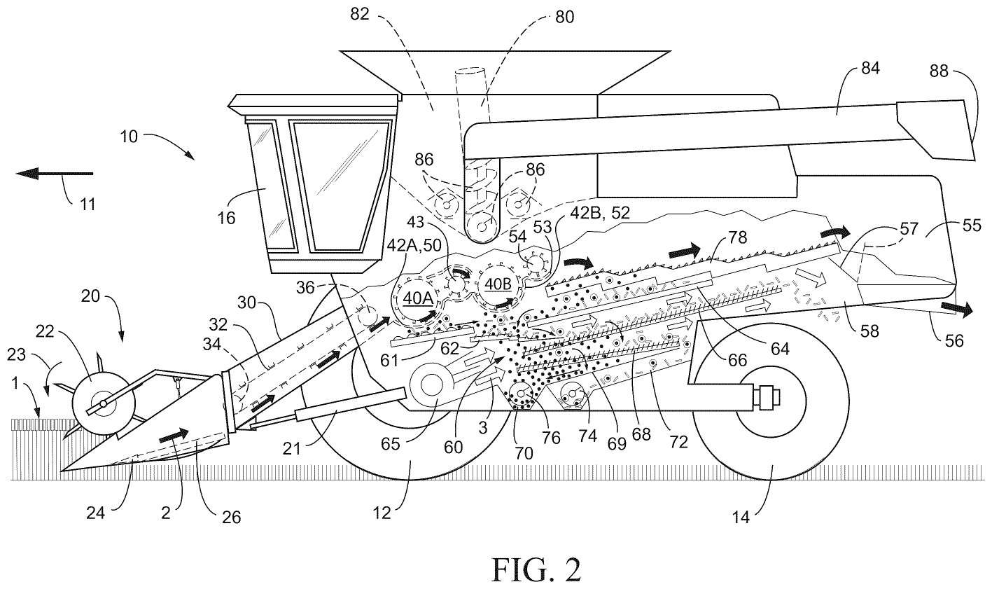

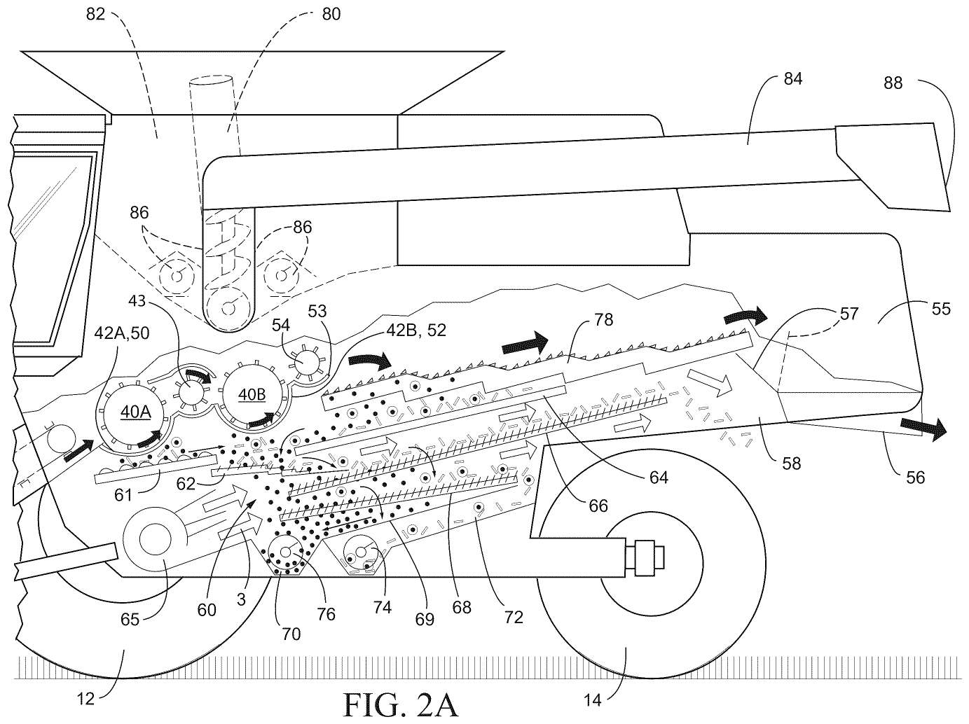

Referring to FIGS. 2 and 2A, the crop material from the header 20, enters the feeder house 30. The feeder house 30 typically includes a feeder house chain or belt 32 extending around a forward drum 34 and rearward drum 36. The feeder house chain or belt 30 feeds the crop material into a threshing rotor 40A. A feeding drum 43 moves the threshed crop from the threshing rotor 40A to the separating rotor 40B. In FIGS. 2 and 2A, the threshing rotor 40A and separating rotor 40B are transverse rotors, in that they are disposed transverse to the forward direction of travel 11 of the combine 10.

Threshing concaves 42A surround or partially surround the threshing rotor 40A defining a threshing zone 50. Separating concaves 42B surround or partially surround the separating rotor 40B defining a separating zone 52. As best illustrated in the perspective view of FIG. 8, the concaves 42 are comprised of concave segments 44 with each segment comprised of a series of spaced curved bars 46 defining narrow slots 48 between the bars 46. The concave segments 44 are received within guide rails (not shown) spaced along the length of the rotors 40A, 40B. The concave segments 44 are received within the guide rails end-to-end to form a circular or partially circular cage surrounding or partially surrounding the circumference of the rotating rotors 40A, 40B in radially outward spaced relation from the outwardly projecting fingers or beaters (not shown) extending from the rotors 40A, 40B. The guide rails receiving the concave segments 44 may be adjustable to vary the radially outward spacing of the concave segments 44 with respect to the outer circumference of the rotors 40A, 40B. Different concaves 42A, 42B with different bar widths, different bar spacings and different width slots are used for different types of crops and different crop conditions. Thus, growers/operators will typically have several sets of concaves 42 that are interchangeably inserted into the guide rails depending on the crop being harvested and crop conditions. The threshing concaves 42A in the threshing zone 50 typically have wider bars 46 or more closely spaced bars 46 and narrower width slots 48. The separating concaves 42B in the separating zone 52 typically have narrower bars 46 or wider spaced bars 46 and wider slots 48. It should be appreciated that as the threshing rotor 40A rotates, the crop material 2 is raked over and along the threshing concaves 42A along the threshing zone 50 to dislodge the grain kernels from the unwanted crop material. The threshed crop material then passes from the threshing zone 50 into the separating zone 52 where the threshed crop material is raked over the separating concaves 42B to separate the grain kernels from the unwanted crop material. The separated grain kernels and smaller pieces of crop material fall by gravity through the slots 48 of the concaves 42A, 42B.

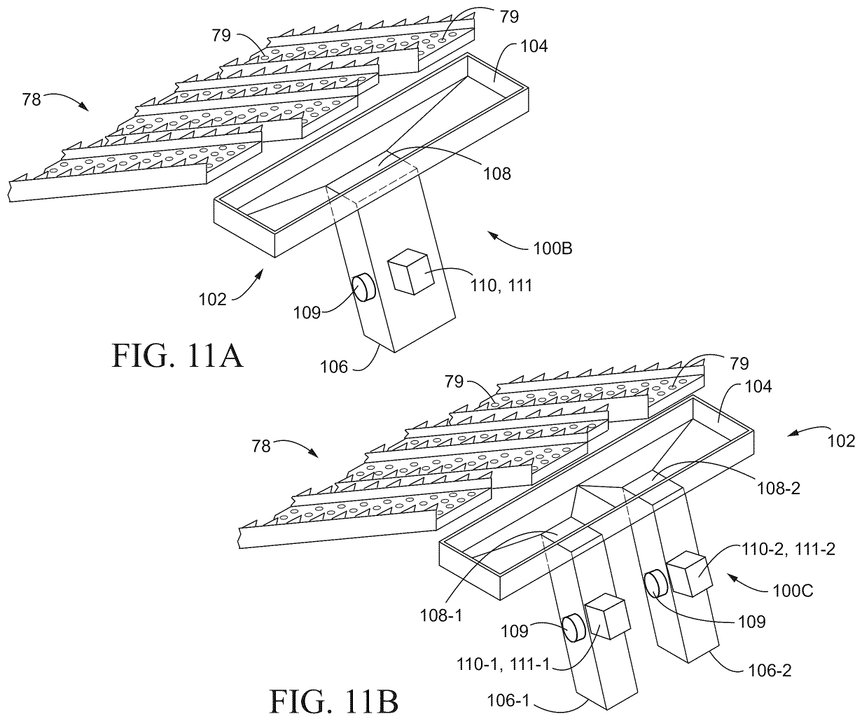

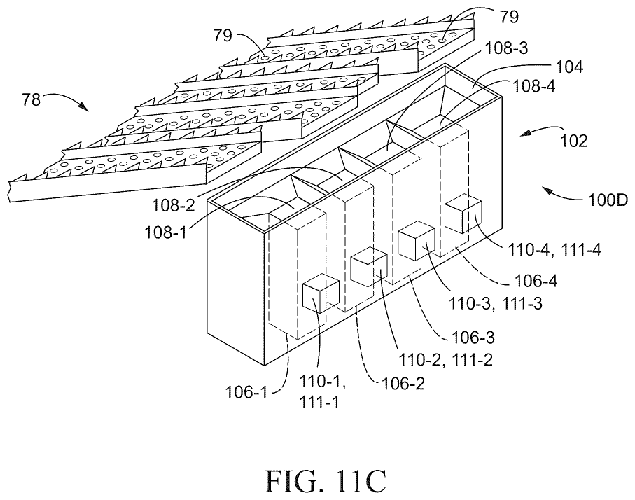

In FIG. 2A, the separated grain kernels are represented by solid black dots. Circled black dots are intended to represent the tailings (defined above). Small open rectangles are intended to represent chaff (defined above). The separated grain kernels, tailings and chaff are shown falling by gravity through the slots 48 of the concaves 42A, 42B along the threshing zone 50 and separating zone 52 of the rotors 40A, 40B (collectively rotor 40). The residue (defined above) is discharged from the separating rotor 40B and may pass under a beater drum 54 rotating above a slotted beater pan 53 to remove any remaining grain kernels that may remain in the residue. The beater drum 54 directs the residue onto oscillating straw walkers 78. Any separated grain kernels that pass onto the straw walkers 78 will ideally pass through openings 79 (discussed later in connection with FIGS. 11A-11C) in the straw walkers 78. The oscillating action of the straw walkers 78 moves or walks the residue toward the rear discharge area 55 of the combine. A deflector door 57 may be selectively positionable to direct the residue from the straw walkers 78 into a residue chopper 56 located in the rear discharge area 55 of the combine. The residue chopper 56 includes chopping blades or knives to chop and spread the residue outwardly behind the combine 10. Alternatively, the deflector door 57 may be positioned as shown in dashed lines to direct the residue from the straw walkers 78 downwardly to a discharge opening 58 in the rear discharge area 55 of the combine so the residue does not pass through the residue chopper 56 and falls downwardly to the ground surface in rows behind the combine 10.

The separated grain kernels, tailings and chaff passing through the slots 48 of the threshing concaves 42A and separating concaves 42B fall by gravity onto the cleaning shoe 60. As previously described, the cleaning shoe 60 may include a forward pan 61, a pre-sieve 62, an upper sieve 66, and a lower sieve 68. The separated grain kernels, tailings and chaff passing through the slots 48 of the threshing concaves 42A in the threshing zone 50 fall onto the forward pan 61 disposed below the threshing rotor 40A. In this embodiment, the forward pan 61 is shown as comprising a series of transversely spaced longitudinal augers which move the separated grain kernels, tailings and chaff rearwardly toward a pre-sieve 62. The separated grain kernels, tailings and chaff passing through the slots 48 of the separating concaves 42B in the separating zone 52 and passing through the beater pan 53 or which pass through the straw walker 78 fall onto the oscillating return pan 64 disposed below the separating rotor 40B. The oscillating action of the return pan 64 moves the separated grain kernels, tailings and chaff forwardly and downwardly as indicated by line arrows toward the forward pan 61 and the pre-sieve 62.

A blower 65 is positioned below the forward pan 61. The blower 65 produces rearwardly directed air streams designated by unfilled arrows 3.

The pre-sieve 62 includes a series of louvers which can be adjustably positioned by an actuator to open and close. The smaller, heavier separated grain kernels pass through openings between the louvers by gravity, but ideally, the louvers prevent the larger pieces of chaff and tailings from passing through the openings between the louvers. Ideally, most of the smaller, lighter chaff on the pre-sieve 62 is blown rearwardly by the air streams 3 passing through the openings between the louvers which carry the lighter chaff toward the upper-sieve or chaffer 66.

The upper sieve or chaffer 66 includes a series of louvers which can be adjustably positioned by an actuator to open and close. The smaller, heavier separated grain kernels pass through openings between the louvers by gravity, but ideally the louvers prevent the larger pieces of chaff and tailings from passing through the openings between the louvers. Ideally, most of the smaller, lighter chaff on the upper sieve 66 is blown rearwardly by the air streams 3 passing over the upper sieve and upward through the openings between the louvers which carry the lighter chaff to the discharge opening 58. The heavier tailings and chaff which are unable to pass through the openings between the louvers continue to be agitated by the oscillating action of the upper sieve 66 so as to ideally dislodge any remaining grain kernels from the tailings and to clean the separated grain kernels from the chaff. The oscillating action of the upper sieve 66 in combination with the louvers also walks the larger chaff, but ideally not the tailings, rearwardly toward the discharge opening 58.

The separated grain kernels and any small tailings and chaff that pass through the openings between the adjustable louvers of the upper sieve 66 drop by gravity onto the oscillating lower sieve 68 disposed below the upper sieve 66. The lower sieve 68 is inclined upwardly from its forward to its rearward end. The lower sieve 68 also includes a series of louvers which can be adjustably positioned by an actuator to open and close. The smaller, heavier separated grain kernels pass through openings between the louvers by gravity, but ideally the position of the louvers prevent the larger pieces of chaff and tailings from passing through the openings between the louvers. The small, heavier separated grain kernels passing through the openings between the louvers fall onto a clean grain pan 69 disposed below the lower sieve 68. The clean grain pan 69 directs the cleaned grain kernels to a clean grain trough 70.

It should be appreciated that the louver positions of the straw walkers 78, pre-sieve 62, upper sieve 66 and the lower sieve 68 are adjusted depending on various factors, including the crop being harvested, the crop conditions, weather conditions, the amount of tailings and chaff on the respective walker 78 and sieves 62, 66, 68, the air speed or air volume from the blower 65, and various other factors.

Most of the chaff remaining on the lower sieve 68 will ideally be blown rearwardly by the air stream out the discharge opening 58. Any tailings that are too large to fall through the openings between the louvers and which are too heavy to be blown by the air stream to the discharge opening 58 are walked rearwardly by the oscillating action of the lower sieve 68 where the tailings drop into the tailings chute 72. A tailings auger 74 is disposed in the bottom of the tailings chute 72. The tailings auger 74 moves the tailings to a tailings elevator (not shown). The tailings elevator returns the tailings to the separating zone 52 of the rotor 40 for recycling through the separating and cleaning stages as described above to ideally ensure that all the grain kernels from the recycled tailings are separated and captured in the clean grain trough 70.

The separated grain kernels that have collected in the clean grain trough 70 are moved by a clean grain auger 76 disposed in a bottom of the clean grain trough 70 to a clean grain elevator (not shown). The clean grain elevator lifts the clean grain kernels upwardly toward a grain tank auger 80. The grain tank auger 80 augers the clean grain kernels into the grain tank 82. The clean grain remains in the grain tank 82 until the clean grain is offloaded to a grain cart or other transport vehicle (not shown) via an unload auger 84. The unload auger 84 swings outwardly from its storage position (shown in FIG. 1) to the unload position (not shown) which is substantially perpendicular to the forward direction of travel 11 of the combine 10. The grain tank 82 includes bottom augers 86 to help move the clean grain to the unload auger 84. The unload auger 84 discharges the clean grain into a grain cart or other transport vehicle positioned below the auger spout 88 of the outwardly extended unload auger 84.

### Combines With a Single Transverse Rotor

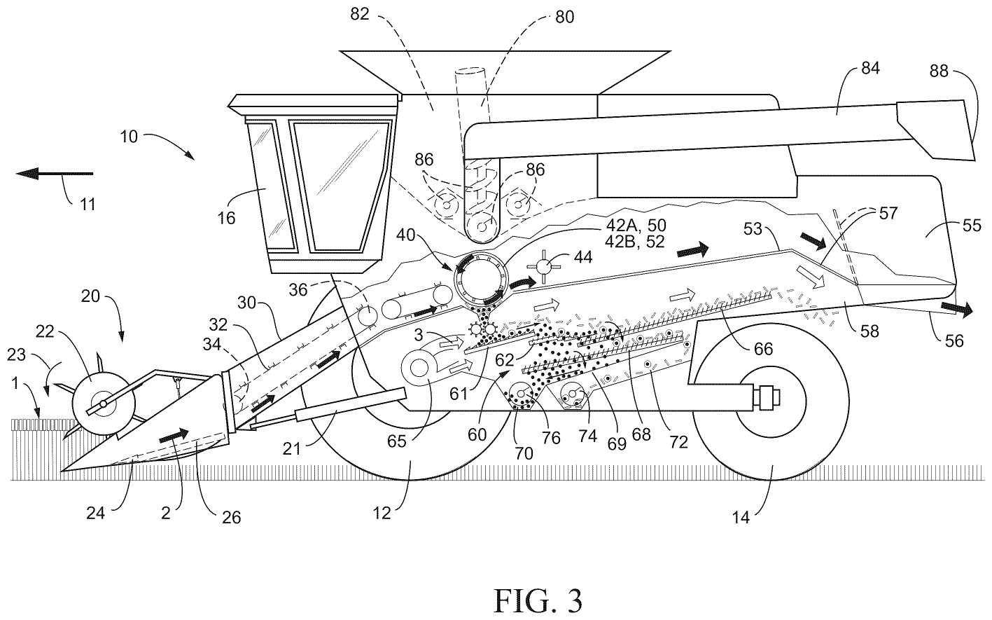

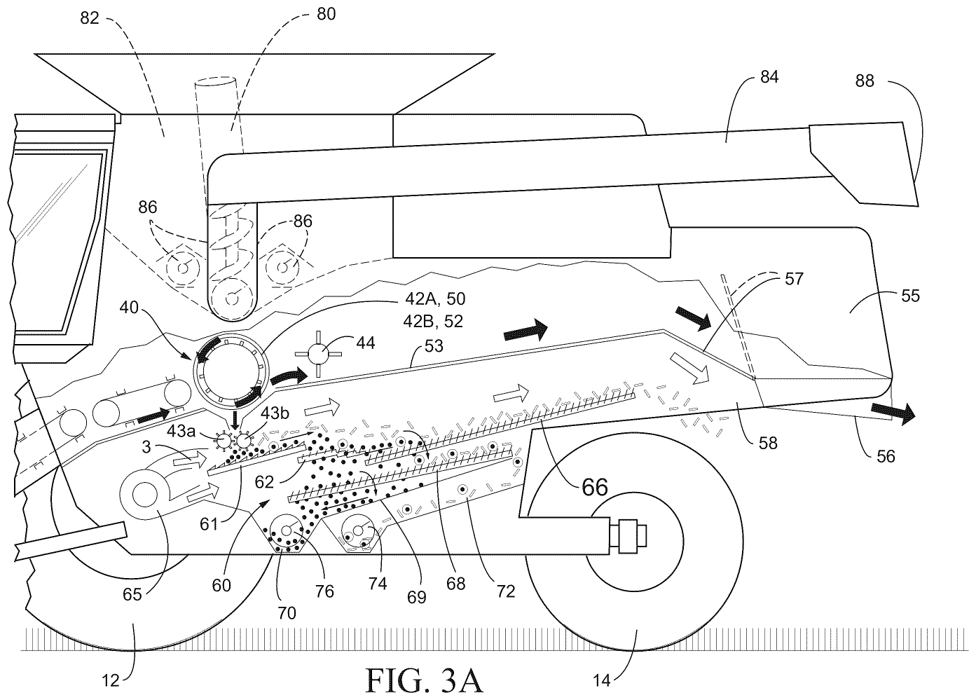

Referring to FIGS. 3 and 3A, the crop material from the header 20, enters the feeder house 30. The feeder house 30 typically includes a feeder house chain or belt 32 extending around a forward drum 34 and rearward drum 36. The feeder house chain 30 feeds the crop material into a rotor 40. In FIGS. 3 and 3A, the rotor 40 is a single transverse rotor, in that it is disposed transverse to the forward direction of travel 11 of the combine 10. The crop material enters the transverse rotor 40 at one end (threshing zone 50) and is moved laterally or transversely toward the other end of the rotor 40 (the separating zone 52).

In the threshing zone 50, the rotor 40 is surrounded or partially surrounded by threshing concaves 42A. In the separating zone 52, the rotor 40 is surrounded or partially surrounded by separating concaves 42B. As best illustrated in the perspective view of FIG. 8, the concaves 42A, 42B are comprised of concave segments 44 with each segment comprised of a series of spaced curved bars 46 defining narrow slots 48 between the bars 46. The concave segments 44 are received within guide rails (not shown) spaced along the length of the rotors 40. The concave segments 44 are received within the guide rails end-to-end to form a circular or partially circular cage surrounding or partially surrounding the circumference of the rotating rotor 40 in radially outward spaced relation from the outwardly projecting fingers or beaters (not shown) extending from the rotor 40. The guide rails receiving the concave segments 44 may be adjustable to vary the radially outward spacing of the concave segments 44 with respect to the outer circumference of the rotor 40. Different concaves 42A, 42B with different bar widths, different bar spacings and different width slots are used for different types of crops and different crop conditions. Thus, growers/operators will typically have several sets of concaves 42 that are interchangeably inserted into the guide rails depending on the crop being harvested and crop conditions. The threshing concaves 42A in the threshing zone 50 typically have wider bars 46 or more closely spaced bars 46 and narrower width slots 48. The separating concaves 42B in the separating zone 52 typically have narrower bars 46 or wider spaced bars 46 and wider slots 48. It should be appreciated that as the rotor 40 rotates, the crop material 2 is raked over and along the threshing concaves 42A along the threshing zone 50 to dislodge the grain kernels from the unwanted crop material. The threshed crop material then passes from the threshing zone 50 into the separating zone 52 where the threshed crop material is raked over the separating concaves 42B to separate the grain kernels from the unwanted crop material. The separated grain kernels and smaller pieces of crop material fall by gravity through the slots 48 of the concaves 42A, 42B.

In FIG. 3A, the separated grain kernels are represented by solid black dots. Circled black dots are intended to represent the tailings (defined above). Small open rectangles are intended to represent chaff (defined above). The separated grain kernels, tailings and chaff are shown falling by gravity through the slots 48 of the concaves 42A, 42B along the threshing zone 50 and separating zone 52 of the rotor 40. In the embodiment shown, the separated grain kernels, tailings and chaff are funneled between a pair of oppositely rotating rollers 43a, 43b which further dislodge the grain kernels from any unwanted crop material.

The residue (defined above) is discharged rearwardly from the rotor 40 and may pass through rotating blades 44 rotating above a discharge pan 53. The rotating blades 44 direct the residue toward the rear discharge area 55 of the combine. A deflector door 57 may be selectively positionable to direct the residue into a residue chopper 56 located in the rear discharge area 55 of the combine. The residue chopper 56 includes chopping blades or knives to chop and spread the residue outwardly behind the combine 10. Alternatively, the deflector door 57 may be positioned as shown in dashed lines to direct the residue downwardly to a discharge opening 58 in the rear discharge area 55 of the combine so the residue does not pass through the residue chopper 56 and falls downwardly to the ground surface in rows behind the combine 10.

The separated grain kernels, tailings and chaff passing through the funnel and rollers 43a, 43b fall onto the cleaning shoe 60. As previously described, the cleaning shoe 60 may include a forward pan 61, a pre-sieve 62, an upper sieve 66, and a lower sieve 68. The separated grain kernels, tailings and chaff initially fall onto the oscillating forward pan 61 disposed below the funnel. The forward pan 61 may include a series of ridges which cooperate with the oscillating action of the forward pan 61 to walk the separated grain kernels, tailings and chaff rearwardly toward a pre-sieve 62.

A blower 65 is positioned below the forward pan 61. The blower 65 produces rearwardly directed air streams designated by unfilled arrows 3. One of the air streams 3 is directed to blow the chaff falling from the funnel and the rollers 43a, 43b rearwardly toward the upper sieve or chaffer 66.

The pre-sieve 62 includes a series of louvers which can be adjustably positioned by an actuator to open and close. The smaller, heavier separated grain kernels pass through openings between the louvers by gravity, but ideally the louvers prevent the larger pieces of chaff and tailings from passing through the openings between the louvers. Ideally, most of the smaller, lighter chaff on the pre-sieve 62 is blown rearwardly by the air streams 3 passing through the openings between the louvers which carry the lighter chaff toward the upper-sieve or chaffer 66.

The upper sieve or chaffer 66 includes a series of louvers which can be adjustably positioned by an actuator to open and close. The smaller, heavier separated grain kernels pass through openings between the louvers by gravity, but ideally the louvers prevent the larger pieces of chaff and tailings from passing through the openings between the louvers. Ideally, most of the smaller, lighter chaff on the upper sieve 66 is blown rearwardly by the air streams 3 passing over the upper sieve and upward through the openings between the louvers which carry the lighter chaff to the discharge opening 58. The heavier tailings and chaff which are unable to pass through the openings between the louvers continue to be agitated by the oscillating action of the upper sieve 66 so as to ideally dislodge any remaining grain kernels from the tailings and to clean the separated grain kernels from the chaff. The oscillating action of the upper sieve 66 in combination with the louvers also walks the larger chaff, but ideally not the tailings, rearwardly toward the discharge opening 58.

The separated grain kernels and any small tailings and chaff that pass through the openings between the adjustable louvers of the upper sieve 66 drop by gravity onto the oscillating lower sieve 68 disposed below the upper sieve 66. The lower sieve 68 is inclined upwardly from its forward to its rearward end. The lower sieve 68 also includes a series of louvers which can be adjustably positioned by an actuator to open and close. The smaller, heavier separated grain kernels pass through openings between the louvers by gravity, but ideally the position of the louvers prevent the larger pieces of chaff and tailings from passing through the openings between the louvers. The small, heavier separated grain kernels passing through the openings between the louvers fall onto a clean grain pan 69 disposed below the lower sieve 68. The clean grain pan 69 directs the cleaned grain kernels to a clean grain trough 70.

It should be appreciated that the louver positions of the pre-sieve 62, the upper sieve 66 and the lower sieve 68 are adjusted depending on various factors, including the crop being harvested, the crop conditions, weather conditions, the amount of tailings and chaff on the respective sieves 62, 66, 68, the air speed or air volume from the blower 65, and various other factors.

Most of the chaff remaining on the lower sieve 68 will ideally be blown rearwardly by the air stream out the discharge opening 58. Any tailings that are too large to fall through the openings between the louvers and which are too heavy to be blown by the air stream to the discharge opening 58 are walked rearwardly by the oscillating action of the lower sieve 68 where the tailings drop into the tailings chute 72. A tailings auger 74 is disposed in the bottom of the tailings chute 72. The tailings auger 74 moves the tailings to a tailings elevator (not shown). The tailings elevator returns the tailings to the separating zone 52 of the rotor 40 for recycling through the separating and cleaning stages as described above to ideally ensure that all the grain kernels from the recycled tailings are separated and captured in the clean grain trough 70.

The separated grain kernels that have collected in the clean grain trough 70 are moved by a clean grain auger 76 disposed in a bottom of the clean grain trough 70 to a clean grain elevator (not shown). The clean grain elevator lifts the clean grain kernels upwardly toward a grain tank auger 80. The grain tank auger 80 augers the clean grain kernels into the grain tank 82. The clean grain remains in the grain tank 82 until the clean grain is offloaded to a grain cart or other transport vehicle (not shown) via an unload auger 84. The unload auger 84 swings outwardly from its storage position (shown in FIG. 1) to the unload position (not shown) which is substantially perpendicular to the forward direction of travel 11 of the combine 10. The grain tank 82 includes bottom augers 86 to help move the clean grain to the unload auger 84. The unload auger 84 discharges the clean grain into a grain cart or other transport vehicle positioned below the auger spout 88 of the outwardly extended unload auger 84.

It should be appreciated that the particular components, their configurations and their positions within the combine as described and illustrated in the drawing figures for performing the threshing, separating and cleaning processes are non-limiting examples. Those of ordinary skill in the art would recognize that different makes and models of combines employ different or additional components at each of the threshing, separating and cleaning stages and the configurations of those components and their positions within the combine may vary. Thus, any reference to the threshing stage should be understood as encompassing any structure or process in which the grain kernels are dislodged or partially dislodged from unwanted crop material. Any reference to the separating stage should be understood as encompassing any structure or process in which the grain kernels are separated or partially separated from unwanted crop material. Any reference to the cleaning stage should be understood as encompassing any structure or process resulting in the grain kernels being free or substantially free from tailings, chaff or other unwanted crop material. Any reference to rotor 40 within this description should be understood as encompassing any rotor used in a combine, whether an axial rotor or a transverse rotor, which receives the crop material from the combine's feeder house and moves the crop material through the threshing and separating stages. Any reference to the concaves 42 should be understood as encompassing any structure that surrounds or partially surrounds the rotor and is employed to thresh the crop material during the threshing stage and employed to separate the grain kernels during the separating stage from a majority of unwanted crop material. Any reference to the return pan 61 should be understood as encompassing any structure that is employed and positioned to receive grain kernels, tailings, chaff or other crop material from the threshing and/or separating stages. Any reference to the forward pan 61 should be understood as encompassing any structure that is employed and positioned to receive grain kernels, tailings, chaff or other crop material from the threshing and/or separating stages. Any reference to sieves 62, 66, 68 should be understood as encompassing any structure that is employed that results in grain kernels being free or substantially free from tailings, chaff or other unwanted crop material. Any reference to the deflector door 57 should be understood as encompassing any structure which directs the residue either into a residue chopper 56 or downwardly toward the discharge opening 58 of the combine. Any reference to the straw walker 78 should be understood as encompassing any structure that moves the residue toward the residue chopper 56 or toward the discharge opening 58 of the combine.

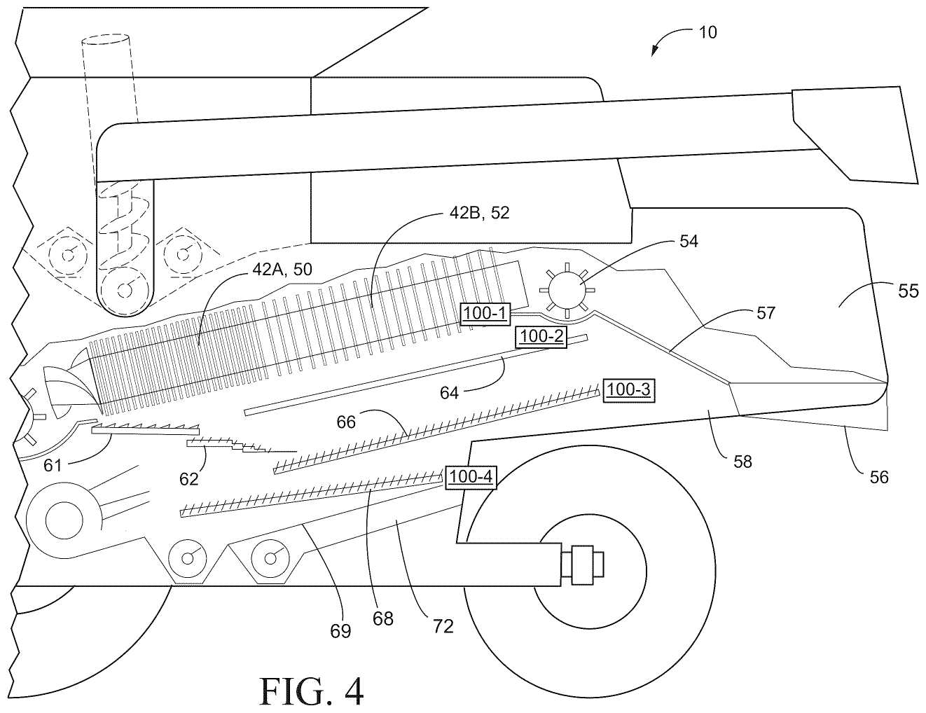

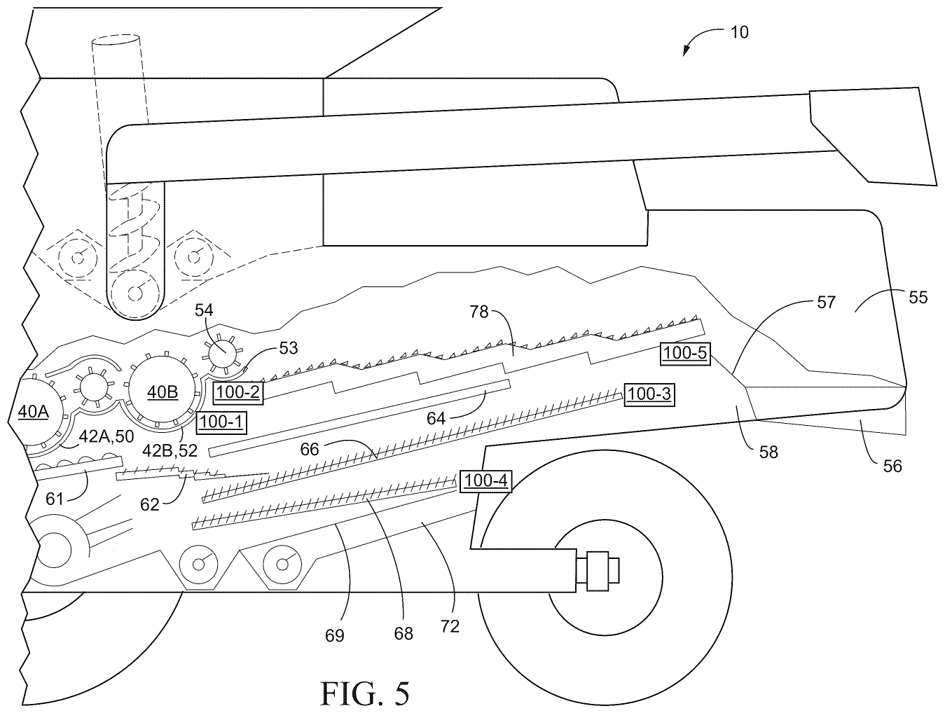

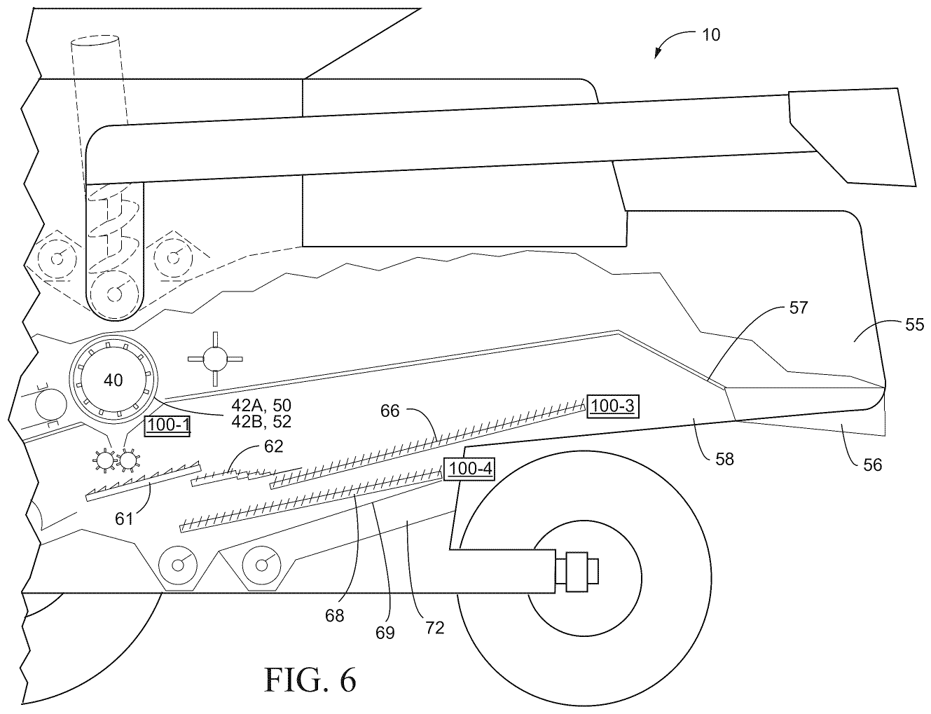

FIG. 4 is a further enlarged partial view of the combine 10 illustrated in FIG. 1A. FIG. 5 is a further enlarged partial view of the combine 10 illustrated in FIG. 2A. FIG. 6 is a further enlarged partial view of the combine 10 illustrated in FIG. 3A. The representations of the separated grain kernels, tailings and chaff are removed from FIGS. 4, 5 and 6 for clarity. FIGS. 4, 5 and 6 also identify certain locations where crop material may be collected and analyzed by a grain loss detector 100 to determine if grain kernels are present, which would be indicative of grain loss occurring. These locations are designated schematically in FIGS. 4, 5 and 6 by boxes labeled 100-1 through 100-5. Regardless of the location of the grain loss detector 100, it should be appreciated that the grain loss detectors 100 are configured and mounted to the combine in a manner that does not affect or interfere with the operation or performance of the combine or any of its components.

Box 100-1 is intended to represent a grain loss detector 100 disposed to receive crop material falling through the slots 48 of the separator concaves 42B at the end of the separating zone 52. Ideally, only chaff would be discharged or fall through the slots 48 of the end of the separating zone 52. If the presence of grain kernels or tailings or both within the collected crop material discharged or falling through the slots 48 of the concaves 42B at the end of the separating zone 52 is detected, it is likely that grain is being lost from the rotor 40 (40B in FIGS. 2 and 2A) (hereinafter “rotor loss”). In combines having dual axial rotors, a grain loss detector 100 may be disposed at the end of the separating zone 52 for each of the dual axial rotors. If rotor loss is detected, the threshing and separation of crop material is likely inadequate which may be due to various factors, including excess radial spacing between the rotor 40 and the concaves 42A, 42B or too little spacing between the rotor 40 and concaves 42A, 42B. Alternatively, improper concaves 42A, 42B for the current crop conditions may be responsible for rotor loss requiring the operator to change out the current concaves with different concaves 42A, 42B having different bar widths, bar spacings and slot spacings. Alternatively, rotor loss may be due to wear of the fingers or beaters on the rotor 40 requiring service to the rotor 40 or replacement of worn concaves 42A, 42B. Rotor loss may also be due to operator error requiring the operator to adjust speed or change other operating parameters.

For combines equipped with a beater pan 53 and beater drum 54 at the end of the rotor 40, a grain loss detector 100 may alternatively be disposed to receive crop material falling through the beater pan 53 as indicated by box 100-2 in FIGS. 4 and 5. Ideally, only chaff would be discharged or fall through the beater pan 53 at location 100-2, but if the grain detector 100 detects the presence of grain kernels or tailings or both in the collected crop material discharged by or falling through the beater pan 53, it would be a strong indication that rotor loss is occurring such that the operator needs to adjust the concave settings or take the corrective measures identified above to reduce rotor loss.

Additionally or alternatively a grain loss detector 100 may be disposed to collect the crop material being discharged from the rearward end of the upper sieve 66 as indicated by box 100-3 in FIGS. 4, 5 and 6. Ideally, the upper sieve 66 would only be discharging chaff from its rearward end, but if the grain loss detector 100 at location 100-3 detects the presence of grain kernels or tailings or both in the collected crop material, then grain loss is occurring from the upper sieves (“upper sieve losses”).

Corrective action for upper sieve losses may include adjusting the louver positions of the upper sieve 66 to allow the separated grain materials to pass through the openings between the louvers more easily. Additionally, or alternatively, upper sieve losses may be indicative of the upper sieve being clogged with chaff or other debris preventing the separated grain kernels from falling through the openings between the louvers of the upper sieve. Additionally, or alternatively, the oscillating action of the upper sieve 66 may need to be adjusted so it is more aggressive or less aggressive. Additionally, or alternatively, the air stream velocity or air stream volume may be excessive resulting in grain kernels and tailings being blown rearward before they are able to pass through the openings between the louvers. Additionally, or alternatively, upper sieve losses may also be attributable to the concaves 42A, 42B not adequately threshing and separating of the grain kernels from the unwanted crop material such that too many or too large of tailings are falling through the slots 48 of the concaves 42A, 42B requiring the corrective adjustment to the concaves 42A, 42B or other corrective action described above under the rotor loss description.

Additionally or alternatively a grain loss detector 100 may be disposed to collect the crop material being discharged from the rearward end of the lower sieve 68 as indicated by box 100-4 in FIGS. 4, 5 and 6. Ideally, the lower sieve 68 would only be discharging tailings from its rearward end, but if the grain loss detector 100 at location 100-4 detects the presence of separated grain kernels in the collected crop material, then it may be indicative that the louvers of the lower sieve 68 may need to be adjusted to permit the separated grain kernels to fall through the lower sieve 68 more easily or it may be indicative of the lower sieve being clogged with chaff or other debris preventing the separated grain kernels from falling through the openings between the louvers.

Additionally, or alternatively, a grain loss detector 100 may be disposed to collect the crop material falling through the openings 79 (see FIGS. 11A-11C) of the straw walker 78 toward the rearward end of the straw walker 78 as indicated by box 100-5 in FIG. 5 to detect grain kernels and or tailings discharged from the rearward end of the straw walkers 78 (“walker loss”). It should be appreciated that walker loss would also be attributed to or associated with rotor loss. Ideally, the straw walkers would only be discharging chaff from its rearward end, but if the grain loss detector 100 at location 100-5 detects the presence of separated grain kernels or tailings in the collected crop material, then it may be indicative of walker loss/rotor loss attributable to the concaves 42A, 42B not adequately threshing and separating of the grain kernels from the unwanted crop material requiring the corrective adjustment to the concaves 42A, 42B or other corrective action described above under the walker loss description.

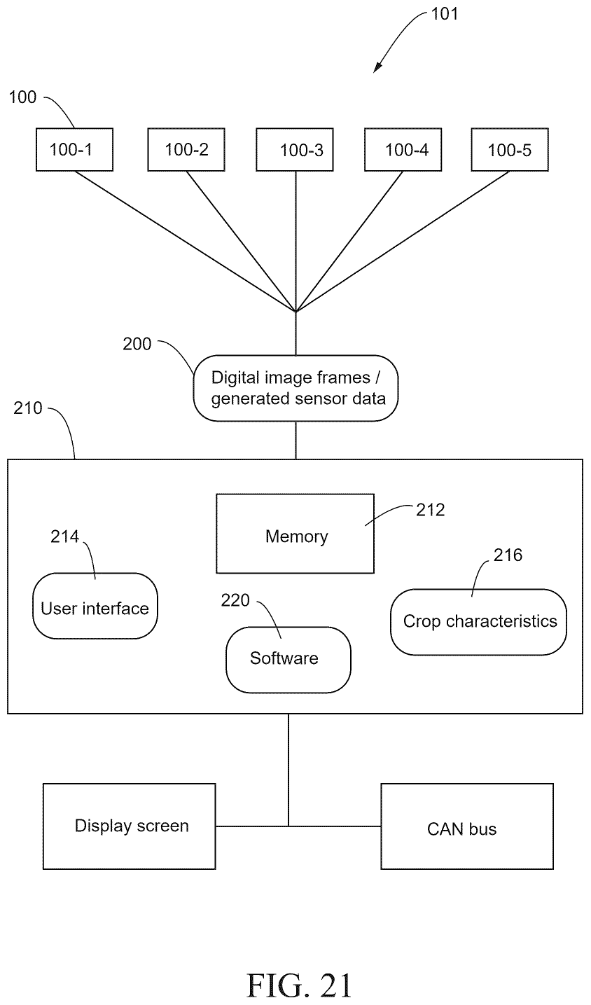

FIG. 21 is a schematic illustration of a grain loss detector system 101. In general, the grain loss detector system 101 includes one or more grain loss detectors 100 disposed in any of the various locations 100-1 to 100-5 of the separating and cleaning stages of the combine as discussed above. Each grain loss detector 100 incorporates at least one sensor 110. Each sensor 110 is in data communication (wired or wirelessly) with a computing device 210. The sensor 110 generates sensor data output 200 which is received and stored in memory 212 of the computing device 210 for processing by software 220. The computing device 210 includes a user interface 214 for use by the operator to input the type of crop being harvested and other relevant inputs discussed later. The software 220 utilizes the operator inputs and draws upon crop characteristics of the crop being harvested from a crop characteristics database 216 to identify the presence of grain kernels among material other than grain (MOG) (i.e., chaff, dust, dirt, etc.) comprising the discharged crop material from the components of the separating and cleaning stages. The grain kernels may be separated grain kernels or the grain kernels may be attached to unwanted crop material (i.e., unseparated grain kernels) also previously referred to as tailings. Other features and functionality of the grain loss detector system 101 and its various components and processes are discussed in more detail below.

The sensor 110 is ideally able to generate accurate sensor data output 200 from which the grain kernels (whether separated or unseparated) are able to identified from within the collected crop material in the extremely dusty environment of the combine, under different moisture or temperature conditions and while experiencing vibrations and rough terrain often associated with harvesting operations. Sensor technologies that may be suitably adapted for the grain loss detector 100 include spatial filter velocimetry, laser diffraction, pressure or force sensitive resistors, pressure mapping capacitive tactile sensors, or any type of sensors that utilize the electromagnetic spectrum, including radio waves, microwaves, infrared waves, visible light, ultraviolet radiation, X-rays, and gamma rays, or which utilize sound waves including ultrasonic waves. For example, one type of sensor that utilizes the electromagnetic energy spectrum which is particularly adapted for sensing particles in dusty environments is disclosed in U.S. Pat. Nos. 6,208,255 and 6,346,888, each of which is incorporated herein by reference. While each of the above-mentioned sensor technologies have their advantages, Applicant has found computer vision (CV) technology is particularly well suited for use in the grain loss detector 100, but it should be appreciated that any of the foregoing sensor technologies may be utilized and may be equally suited or better suited than CV technology for the grain loss detector 100.

In embodiments utilizing CV technology, the sensor 110 may comprise a still camera or video camera that generates the sensor data output 200 in the form of digital image frames 200. The digital image frames 200 are communicated (via wire or wireless technology) to the computing device 210. The computing device 210 includes memory 212 for storing the received digital image frames 200 and the software 220 processes the digital image frames 200 as described in more detail later to identify any grain kernels within the digital image frames 200. The software 220 may include, or may be in data communication with, a crop characteristic database 216 containing crop characteristics associated with the crop being harvested. In one embodiment, the camera 110 may be an RGB camera (i.e., a camera which captures color images by capturing light in red, green, and blue (RGB) wavelengths).

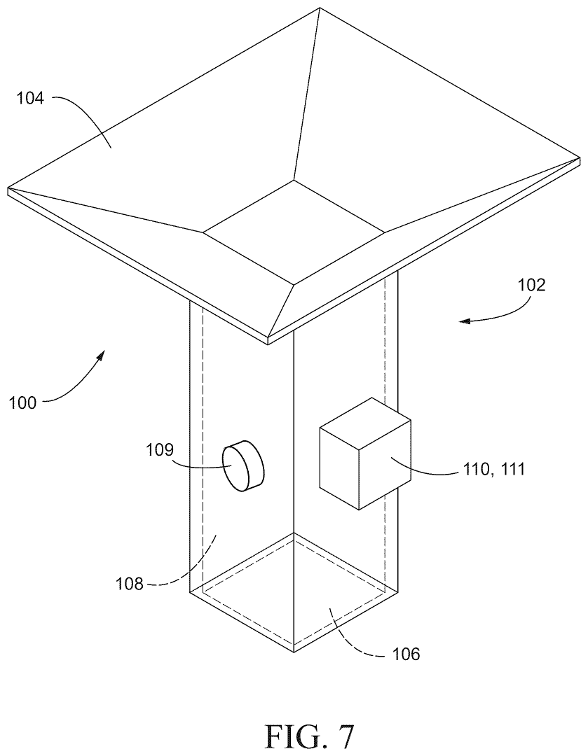

FIG. 7 is a general representation of one embodiment of a grain loss detector 100. In this embodiment, the grain loss detector 100 includes a collector 102 having an inlet end 104 and an outlet end 106. A channel or passage 108 connects the inlet end 104 and the outlet end 106. The inlet end 104 is positioned to collect crop material at the locations 100-1, 100-2, 100-3, 100-4, 100-5 discussed above or other desired locations. The camera or other sensor 110 is disposed within the collector 102 between the inlet and outlet ends 104, 106 and is in communication with the channel 108 such that the crop material entering the inlet end 104 will flow through the channel 108 past the camera or other sensor 110 before exiting the outlet end 106. It should be apparent that the particular shape of the collector 102 may vary depending on its intended location within the combine and depending on the make and model of combine being used as discussed later. It should also be appreciated that the collector 102 not only serves to collect the crop material and direct the crop material past the camera or other sensor 110, but the channel or passage 108 through the collector 102 also provides an environment for the camera or other sensor 110 that is much less exposed to the chaff, dust, dirt and debris blowing through the interior of the combine. The channel or passage 108 may have an anti-static coating or may be made from an anti-static material, such as ultra-high molecular weight polyethylene (UMHW), polytetrafluoroethylene (PTFE), thermoplastic polyurethane (TPU) or similar materials to reduce the amount of dust accumulation within the channel or passage 108 that may adversely affect the performance of the camera or other sensor 110.

Lights 109 may be provided in the channel 108 or around the channel 108 to illuminate the channel 108 when generating the digital image frames 200. The lights 109 may be in signal communication with the computing device 210. The software 220 may be programmed to turn the lights 109 on and off before and after each digital image 200 is generated, or the software 220 may be programmed to turn the lights 109 on just before the digital images 200 are generated and to stay on for a predetermined duration. Alternatively, the lights 109 may be always on.

Small fans (not shown) may also be mounted to the collector 102 to blow an airstream into the channel 108 or the fans may be located at or near the inlet end 104 of the collector to eliminate or reduce the dust, debris and fine short straw within the channel 108 for obtaining better digital image fames without obstruction by dust, debris or fine straw. The fans may be in signal communication with the computing device 210. The software 220 may be programmed to turn the fans on for a period of time before the digital images are generated and programmed to turn off after a predetermined duration or the fans may be always on.

The software 220 used to process the digital image frames 200 is configured to detect and differentiate grain kernels from the MOG. The software 220 is preferably a machine learning (ML) software that employs artificial intelligence (AI) or machine learning algorithms using crop data characteristics associated with the particular crop being harvested. The crop data characteristics associated with the crop being harvested may include color characteristics of the grain kernels, shape characteristics of the grain kernels, and size characteristics of the grain kernels. The crop data characteristics may also include color, shape and size characteristics of the MOG associated with the crop being harvested. The crop data characteristics may also include historical digital image frames of the crop being harvested against which the digital image frames 200 may be compared to improve the detection and differentiation of the grain kernels from MOG. For example, the type of crop being harvested may be input by the operator via a user interface associated with the computing device 210 before harvesting operations begin. The machine learning algorithms can then utilize the crop type input by the operator to draw on the crop data characteristics, including historical digital image frames, associated with the crop selected by the operator. For example, if the combine is to be used to harvest soybeans, the software 220 may allow the operator to select an input for “soybeans” among various other selectable crop types (i.e., corn, wheat, barley, oats, etc.) through the user interface. The software 220 could then draw on the crop data characteristics associated with soybeans, such as the round or oval shape of the soybean grain kernels, the size of the soybean grain kernels and the golden yellow color of soybean grain kernels as opposed to the color and shape of the pods, stems, leaves and foreign material comprising the MOG that may also be captured within the digital image frames 200, in order to aid in identify the presence of any soybean kernels within the MOG. Alternatively, the software 220 may utilize machine learning algorithms to determine the type of crop being harvested (i.e., corn, soybeans, wheat, etc.) based on comparison of the digital image frames 200 with historical digital image frame data without the operator inputting the crop type.

Any of the other types of sensors 110 described above may also be employed in combination with or in place of the camera 110. These other types of sensors 110 may be able to detect the density, shape, size or other characteristics of the material passing through the channel 108. With such other types of sensors 110, the software 220 may be able to draw on other types of crop data characteristics associated with the crop being harvested, such as a typical range of densities, shapes, sizes, dielectric constants, etc. of the grain kernels and the densities, shapes or characteristics of the pods, stems, leaves or foreign material comprising the MOG. It should be appreciated that the characteristics associated with different types of grain kernels and MOG associated with different types of crops would be referenced from the crop data characteristics depending on the respective crop being harvested as input by the operator, whether corn, wheat, barley, oats, etc.

Still other types of sensors in communication with the computing device 210 may be employed to measure the velocity of the crop material passing the sensor, or the software 220 may be programmed to calculate the speed of the crop material based on the time difference between sequential digital image frames 200 and the positional difference of the passing crop material within the sequential digital image frames 200. The measurement or detection of the velocity of the passing crop material may aid in the detection of grain kernels. For example, lighter chaff having a greater surface area may have a higher velocity than the heavier, smaller grain kernels. This difference in velocity may aid in differentiating between the slower moving grain kernels and the faster moving MOG.

Additionally, the software 220 may also be programmed to count the number of identified grain kernels within each of the sequential digital image frames 200 (or within the sensor data generated by the other types of sensors) whether the grain kernels are separated or unseparated from MOG. The software 220 may also be programmed to sum the counted seeds to quantify the identified grain kernels within the sequential digital image frames 200 (or sequential sensor data 200 generated by the other types of sensors 110) over a predefined time period to determine a grain loss amount. The software 220 may correlate the grain loss amount as ratio of predefined units of yield loss (e.g., bushels lost per acre). The software 220 may also correlate the grain loss amount in terms of economic loss (e.g., dollars lost per acre or dollars lost per hour). To generate such data, the software 220 may interface with the combine's yield monitor data to determine the bushels per acre being harvested which can then be correlated with the grain loss amount to arrive at a percentage loss per acre from which the economic loss in dollars per acre can be calculated. To generate the dollars lost per acre, the operator may input a current price of the crop being harvested or a preset or assumed price for the crop being harvested may be used as a default based on historical averages. The yield loss and economic loss may be displayed on a screen visible to the operator. In embodiments utilizing CV technology capturing digital image frames, the captured digital image frames 200 may be selectively displayed on a screen visible to the operator.

The software 220 may also be programmed to display recommended corrective actions to optimize operating parameters of the components of the threshing, separating and cleaning stages. For example, upon detection of rotor loss or sieve loss or excessive separated grain kernels entering the tailings chute 72, the software 220 may be programmed to display a recommended corrective actions to be taken by the operator to optimize the combine's settings to minimize grain loss. The recommended corrective actions may be displayed on the combine's monitor display screen or a separate display screen in signal communication with the computing device 210. Examples of the types of corrective measures that may be displayed may be those identified above under the discussion of the factors that may be attributable to rotor loss, sieve loss and excessive separated grain kernels entering the tailings chute.

The software 220 may also interface with the combine's Controller Area Network bus (CAN bus) used to electronically control the operating parameters of the components of the threshing, separating and cleaning stages to make automatic adjustments to optimize the combines settings to minimize losses based on the data from the respective grain loss detectors 100 at the different locations 100-1, 100-2, 100-3, 100-4, 100-5 on the combine to optimize the combine's settings to minimize grain loss or excessive tailings entering the tailings chute 72, for example.

FIG. 8 illustrates an embodiment of a grain loss detector 100A adapted for collecting crop material at the end of the separating zone 52 at location 100-1 as discussed above. As with the general representation of the grain loss detector 100 described above, in this embodiment the grain loss detector 100A includes a collector 102 having an inlet end 104 and an outlet end 106. The inlet end 104 is positioned to collect crop material discharged or passing through the slots 48 at the rearward end of the separating concaves 42B. In one embodiment, the grain loss detector 100A utilizes a camera 110 is disposed within the collector 102 between the inlet and outlet ends 104, 106 such that the crop material entering the inlet end 104 and flowing through the channel 108 toward the outlet 106 will pass the camera 110 transversely before exiting the outlet end 106. The camera 110 may be disposed within a housing 111 mounted to the collector 102. The inlet end 104 may include a cover or lid 112 that may be opened when it is desired to collect samples of the crop material and the lid 112 may be closed when samples are not being collected. The lid 112 may be manually opened and closed by the combine operator or the lid 112 may be equipped with an actuator (not shown) that may be actuated by the operator when it is desired to collect a sample of the crop material and actuated to close when crop material samples are not being collected. When in the open position, the lid 112 may also serve to direct the crop material from the separator concave 42B into the inlet 104. When the lid 112 is closed, any crop material landing on the closed lid will fall onto the return pan 64 as shown in FIG. 4 or 5. In alternative embodiments, the lid 112 may be a brush style. The outlet end 106 is shown as exiting through a side panel of the combine 10 laterally adjacent to the return pan 64. Alternatively, the outlet end 106 may be disposed to return the crop material to the upper sieve 66. The particular shape of the collector 102 and its location within the combine may vary depending on the make and model of combine. For example, if the combine has a transverse rotor as shown in FIGS. 5 and 6, a different configuration of the collector 102 may be required so it may be mounted to receive the crop material at the end of the separating zone 52 and the outlet end 106 may discharge the crop material onto the return pan or forward pan, by way of example. It should be appreciated that in addition to the camera 110, any of the various types of other sensors 110 described above may also be employed with the grain loss detector 100A.

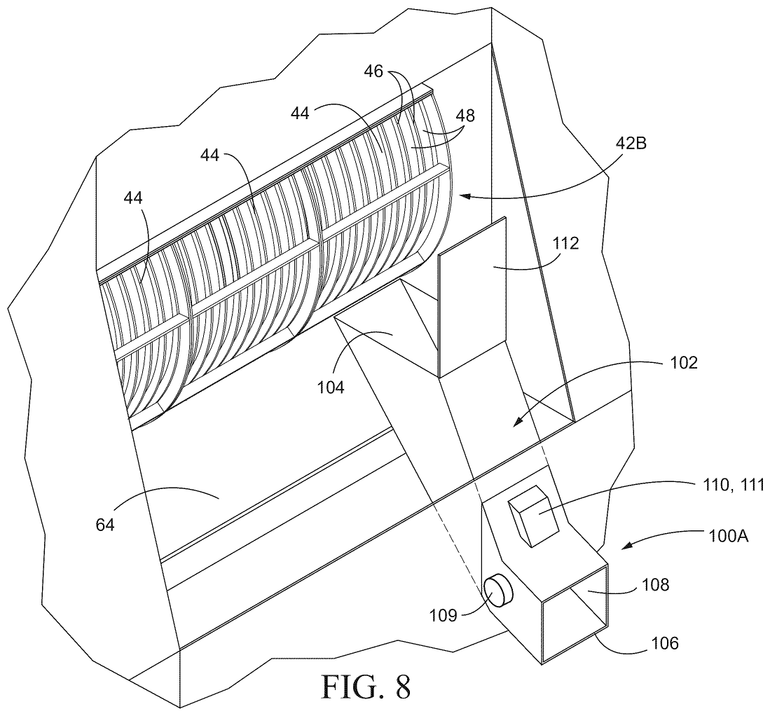

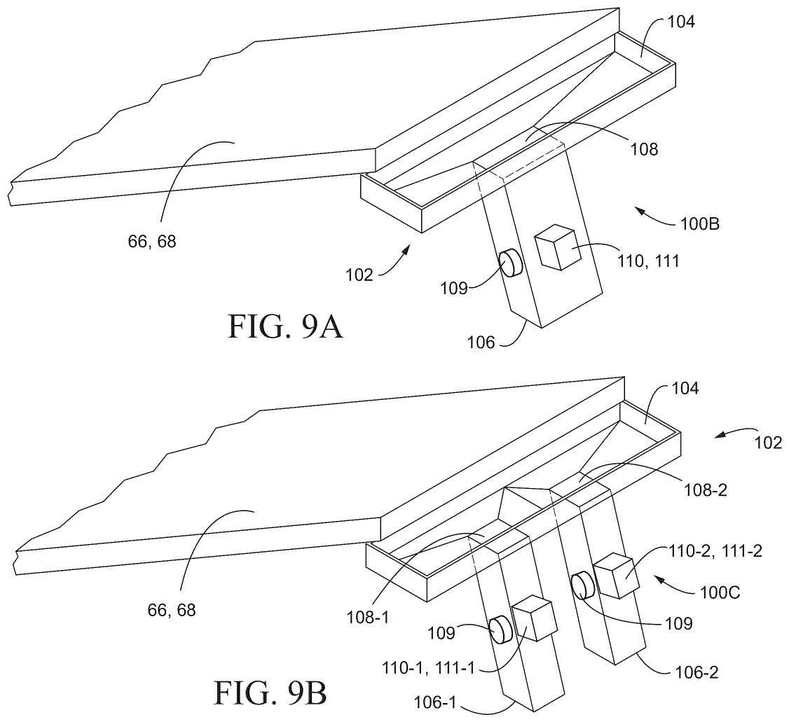

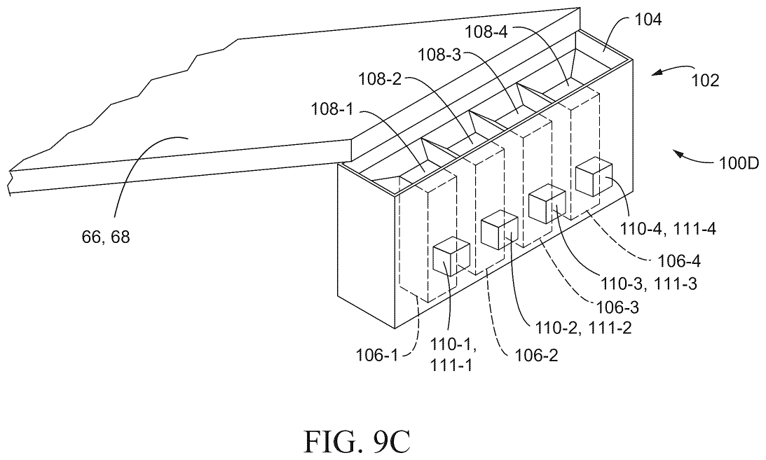

FIGS. 9A-9C illustrate different embodiments of a grain loss detector 100B, 100C, 100D, respectively, adapted for collecting crop material at the rearward end of the upper sieve 66 at location 100-3 as discussed above. As with the general representation of the grain loss detector 100 described above, in the embodiments the grain loss detectors 100B, 100C, 100D each includes a collector 102 having an inlet end 104 and an outlet end 106. The inlet end 104 is positioned to collect crop material being discharged from the rearward end of the upper sieve 66. In one embodiment, the grain loss detectors 100B, 100C, 100D utilize cameras 110 disposed within the collector 102 between the inlet and outlet ends 104, 106 such that the crop material entering the inlet end 104 and flowing through the channel 108 toward the outlet end 106 will pass the camera 110 transversely. The camera 110 may be disposed within a housing 111 mounted to the collector 102. The inlet end 104 may include a cover or lid (not shown) that may be opened manually by the operator when it is desired to collect a sample of the crop material, or the door may be equipped with an actuator (not shown) that may be actuated by the operator when it is desired to collect a sample of the crop material. When in the open position, the lid 112 may also serve to direct the crop material from the rearward end of the upper sieve 66 into the inlet 104. When the lid 112 is closed, any crop material from the upper sieve 66 will pass over the closed lid and exit from the combine through the discharge opening 58 and onto the ground. In alternative embodiments, the lid 112 may be a brush style as described above. It should be appreciated that in addition to the camera 110, any of the various types of other sensors 110 described above may also be employed with any of the grain loss detectors 100B, 100C, 100D.

In the grain loss detector 100B shown in FIG. 9A, the inlet end 104 of the collector 102 extends across the width of the upper sieve 66. From the inlet end 104, the collector 102 is configured as a funnel to direct the crop material downwardly and inwardly to a single channel 108 that extends downwardly and rearwardly with the outlet end 106 at the lower end of the channel 108. The camera 110 is disposed in the channel 108. Again the particular shape of the collector 102 and the manner of mounting the collector 102 to the combine may vary depending on the make and model of combine.

In the grain loss detector 100C shown in FIG. 9B, the inlet end 104 of the collector 102 extends across the width of the upper sieve 66 and the inlet end 104 of the collector 102 is configured as a funnel to direct the crop material downwardly and rearwardly. In the embodiment 100C, two separate channels 108-1, 108-2 are provided. Each channel 108-1, 108-2 has a separate outlet end 106-1, 106-2 and each channel 108-1, 108-2 includes a camera 110-1, 110-2 disposed within a respective housing 111-1, 111-2. Again, the particular shape of the collector 102 and the manner of mounting the collector 102 to the combine may vary depending on the make and model of combine.

In the grain loss detector 100D shown in FIG. 9C, the inlet end 104 of the collector 102 extends across the width of the upper sieve 66 and the inlet end 104 of the collector 102 is configured as a funnel to direct the crop material downwardly and rearwardly into four channels 108-1, 108-2, 108-2, 108-4. Each channel 108-1, 108-2, 108-3, 108-4 has a separate outlet end 106-1, 106-2, 106-3, 106-4 and each channel includes a separate camera 110-1, 110-2, 110-3, 110-4 which may be disposed within a respective housing 111-1, 111-2, 111-3, 111-4. Again, the particular shape of the collector 102 and the manner of mounting the collector 102 to the combine may vary depending on the make and model of combine.

It should be appreciated that each of the grain loss detector embodiments 100B, 100C, 100D may also be adapted to mount rearward of the return pan to detect return pan losses as described above.

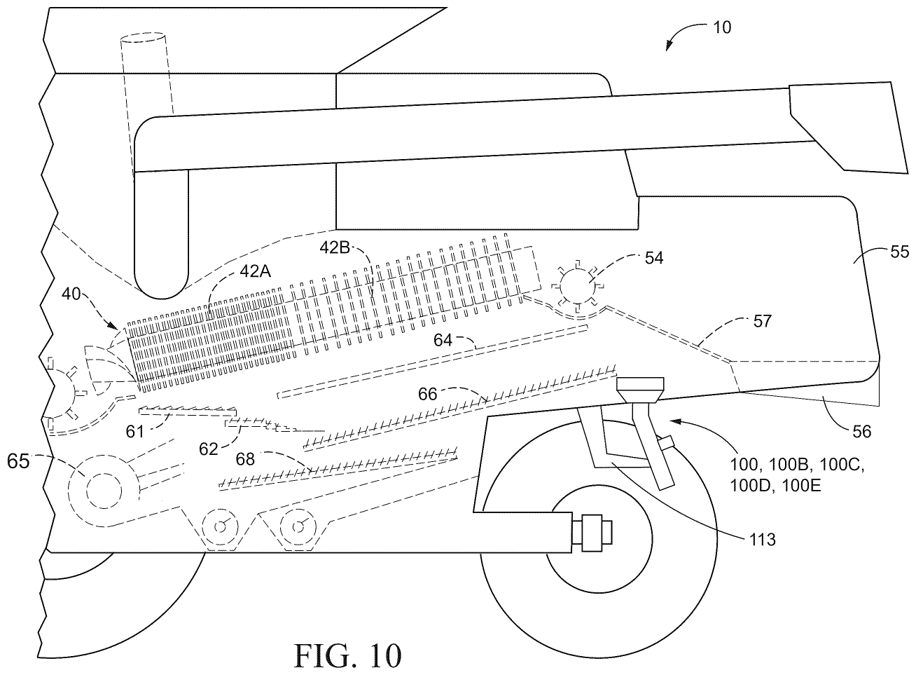

FIG. 10 is a partial side elevation view of a combine 10 as shown in FIG. 4 and illustrating the grain loss detector 100, 100B, 100C, 100D described above mounted rearward of the upper sieve 66 and disposed to receive the crop material discharged by the upper sieve 66 to detect the presence of grain kernels. Appropriate bracing or mounting brackets 113 extending from the combine's chassis or frame is provided to securely support the grain loss detector 100, 100B, 100C, 100D.

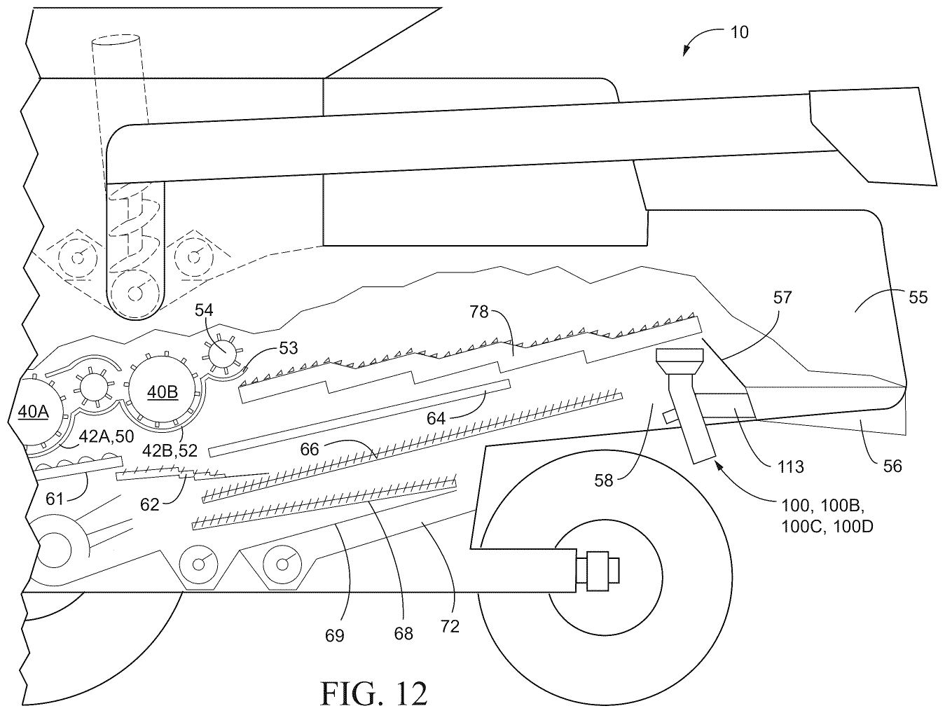

As shown in FIGS. 11A-11C each of the above described grain loss detectors 1100, 100B, 100C, 100D may be adapted to detect walker loss in combines with straw walkers 78 by disposing the grain loss detector 100 below the rearward end of the straw walker 78 to collect the crop material discharged from or passing through the rearward-most openings 79 of the straw walkers 78. Referring to FIG. 12, it should be appreciated that the grain loss detector 100 is positioned forward of the deflector door 57 and below the straw walker 78 such that the majority of the crop residue will continue to be discharged from the rearward end of the straw walkers 78 and into the residue chopper 56, while the grain loss detector 100 collects only the crop material that passes through the openings 79 of the straw walker 78. Appropriate bracing or mounting brackets 113 extending from the combine's frame or other components is provided to securely support the grain loss detector 100B, 100C, 100D below the straw walkers 78. Again the particular shape of the collector 102 and the manner of mounting the collector 102 to the combine below the straw walker 78 may vary depending on the make and model of combine.

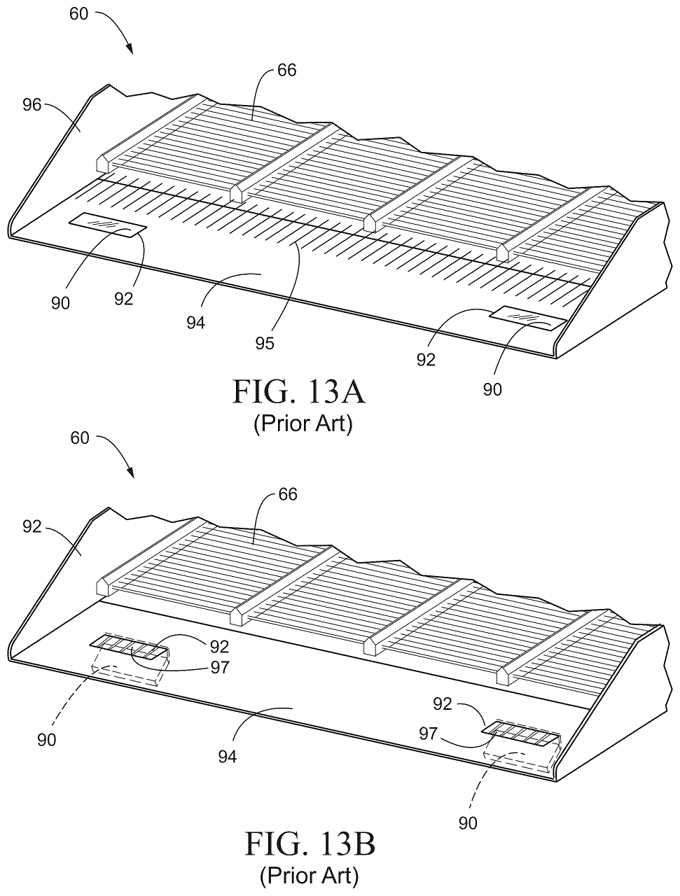

FIG. 13A is a rearward perspective view of a portion of a cleaning shoe 60 of a combine harvester equipped with conventional or prior art sieve loss sensors 90 disposed within openings 92 in a rear pan 94 of the cleaning shoe frame 96. These conventional or prior art sieve loss sensors 90 are configured to detect the presence of grain kernels passing over the face of the sieve loss sensors 90 indicating sieve losses. These conventional or prior art sieve loss sensors are typically piezoelectric sensors that generate a particular electrical signal in response to grain kernels impacting or passing over the sensor surface as opposed to chaff. In the embodiment of FIG. 13A, the cleaning shoe 60 is shown as being equipped with cleaning shoe fingers 95 extending rearwardly from the upper sieve 66 of the cleaning shoe 60. In use, the cleaning shoe fingers 95 carry the larger pieces of chaff rearwardly while allowing any separated grain kernels or small tailings to fall between the fingers 95 onto the rear pan 94 of the cleaning shoe 60 where they are then theoretically detected by the sieve loss sensors 90. FIG. 13B is another rearward perspective view of a portion of a cleaning shoe 60 equipped with conventional or prior art sieve loss sensors 90 disposed in a downwardly sloped angle below openings 92 in a rear pan 94 of the cleaning shoe frame 96. Again, these conventional or prior art sieve loss sensors 90 are configured to detect the presence of grain kernels passing over the face of the sieve loss sensors 90 indicating sieve losses. In the embodiment of FIG. 13B, spaced bars 97 are shown extending over the openings 92 allowing the grain kernels and small tailings to fall between the bars 97 and through the opening 92 while preventing larger pieces of chaff from falling through the openings 92. In still other embodiments, the sieve loss sensors 90 comprise piezoelectric plate sensors extending across or partially across the width of the upper sieve 66. In such embodiments, these piezoelectric plate sensors 90 are configured to detect the presence of grain kernels passing over an upper surface of the piezoelectric plate sensors 90 indicating sieve losses. None of the foregoing conventional or prior sieve loss sensors 90 are not particularly reliable or accurate during operation because they are often obstructed by dust, chaff and other crop residue preventing the accurate detection of sieve losses. Accordingly, an improved grain loss sensor is needed to detect sieve losses.

As used herein, any reference to the rear pan 94 should be understood as encompassing any plate or structure that is rearward of the rearward end of the upper sieves 66 onto which the crop material being discharged by the sieves will fall or pass over, whether or not such plate or structure is a part of the cleaning shoe 60. In certain embodiments, the rear pan 94 may comprise the piezoelectric plate sensor 90 as described above.

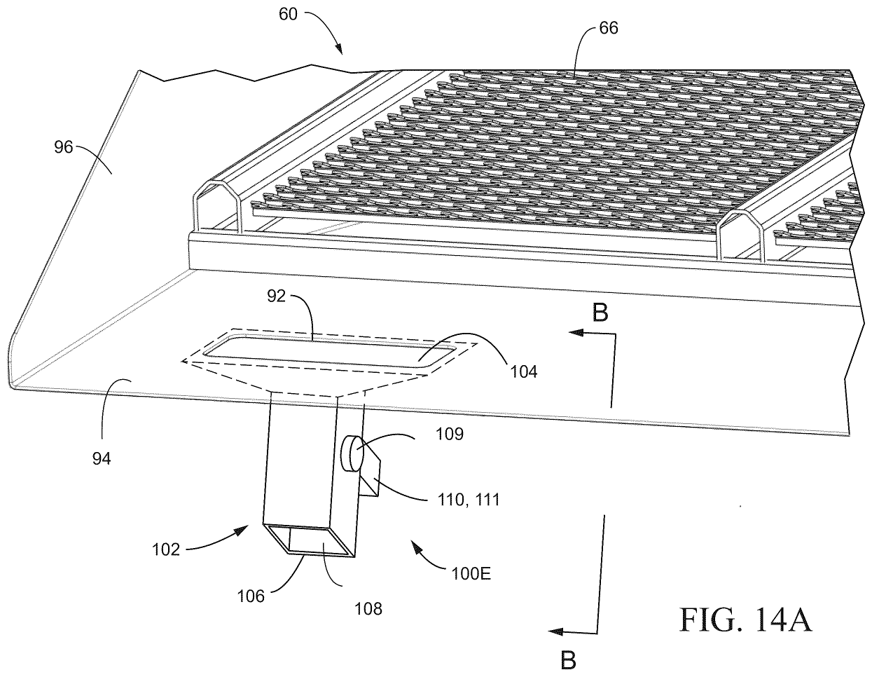

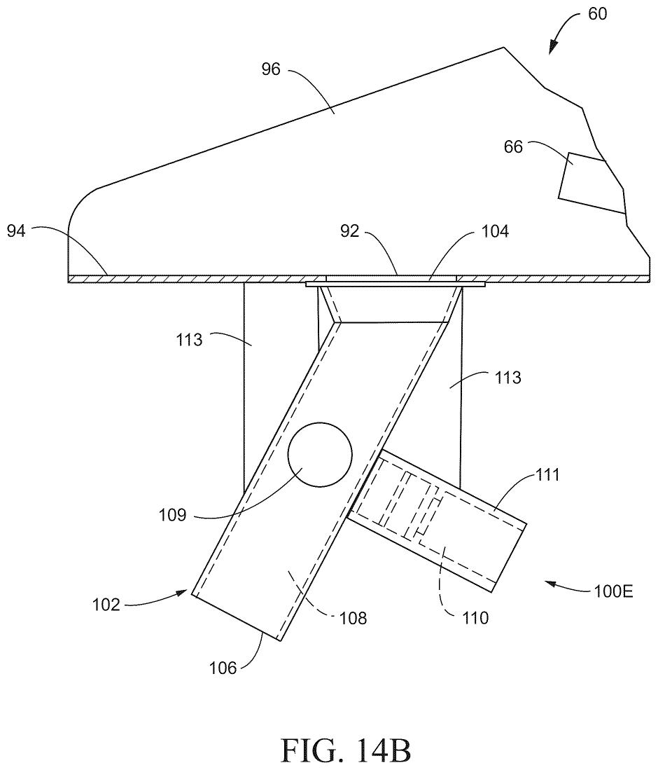

FIG. 14A is a rearward perspective view of an embodiment of a grain loss detector 100E that utilizes openings 92 in the rear pan 94. The openings 92 may be cut into the rear pan 94 or the openings 92 may be existing openings remaining after the conventional or prior art sieve loss sensors 90 as shown in FIGS. 13A or 13B are removed. It should be appreciated that the grain loss detector 100E is thus at or near location 100-3 as discussed above. FIG. 14B is a side elevation view of the grain loss detector 100E as viewed along lines B-B of FIG. 14A. As with the general representation of the grain loss detector 100 described above, in this embodiment, the grain loss detector 100E includes a collector 102 having an inlet end 104 and an outlet end 106. A channel or passage 108 connects the inlet end 104 and the outlet end 106. The inlet end 104 is positioned below the opening 92 to collect crop material as it passes through the opening 92 after being discharged from the rearward end of the upper sieve 66. In this embodiment, the channel 108 is shown angled downwardly and rearwardly with the camera 110 disposed on the forward or lower side of the collector 102 between the inlet and outlet ends 104, 106, such that as the crop material passes through the channel 108, the crop material will slide along the lower wall of the channel 108 and transversely past the camera 110, thereby slowing down the flow of the crop material as it passes through the channel 108 over the camera 110 before exiting the outlet end 106. In FIG. 14B, the camera 110 is disposed within a housing 111. The collector 102 is mounted to the underside of the rear pan 94 by mounting brackets 113. Also as previously described, lights 109 may be provided in the channel 108 or around the channel 108 to illuminate the channel 108 when generating the digital image frames 200. The lights 109 may be programmed to turn on and off before and after each digital image is generated, or the lights 109 may be programmed to turn on just before the digital images are generated and to stay on for a programmable duration. Alternatively, the lights 109 may be always on. Small fans (not shown) may also be mounted to the collector 102 to blow an airstream into the channel 108 or the fans may be located at or near the inlet end 104 of the collector to eliminate or reduce the dust, debris and fine short straw within the channel 108 for better digital image fames for processing by the software 220 without obstruction by dust, debris or fine straw. Although not shown, the channel 108 may be disposed vertically and the camera 100 may be disposed on the rearward wall or on either of the lateral sidewalls of the channel 108. It should be appreciated that in addition to the camera 110, any of the various types of other sensors 110 described above may also be employed in cooperation with the camera 110 or in place of the camera 110 for the grain loss detector 100E.

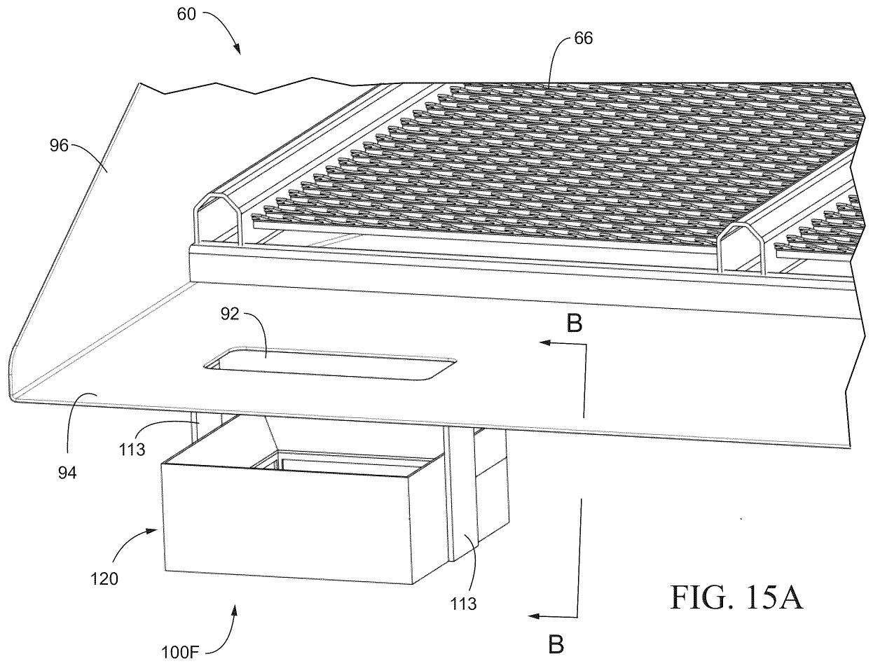

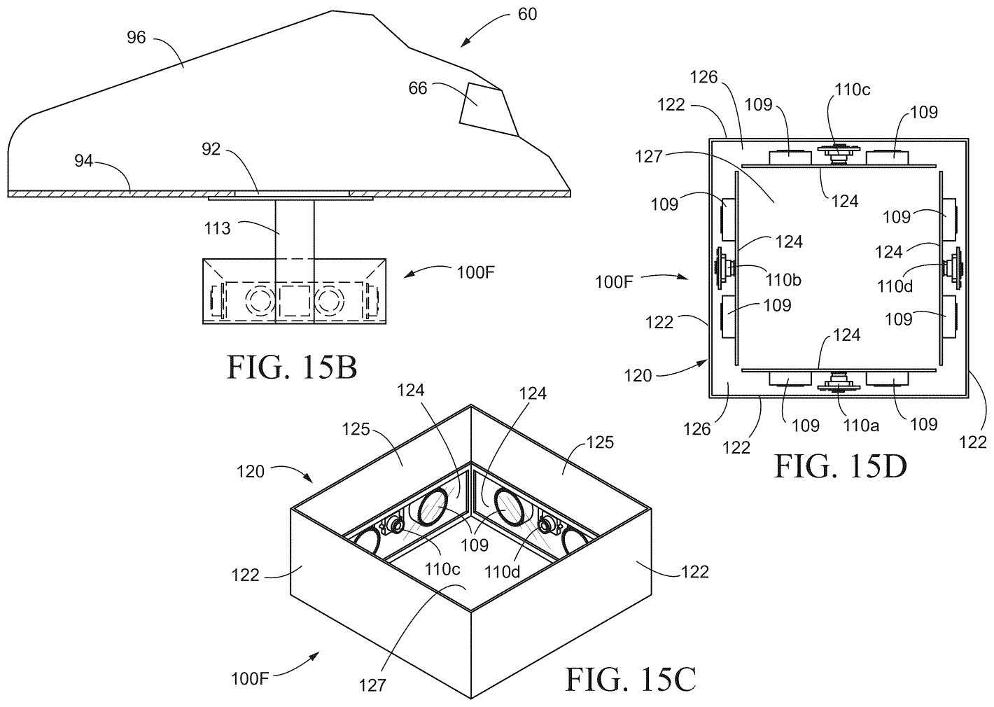

FIG. 15A is a rearward perspective view of another embodiment of a grain loss detector 100F that utilizes openings 92 in the rear pan 94. The openings 92 may be cut into the rear pan 94 or the openings 92 may be existing openings remaining after the conventional or prior art sieve loss sensors 90 as shown in FIGS. 13A or 13B are removed. It should be appreciated that the grain loss detector 100F is thus at or near location 100-3 as discussed above. FIG. 15B is a side elevation view of the grain loss detector 100F as viewed along lines B-B of FIG. 15A. In this embodiment, the grain loss detector 100F omits a collector 102. Instead, the grain loss detector 100F, includes an enclosed frame 120 positioned below the opening 92 such that any crop material passing through the opening 92 falls through the enclosed frame 120. FIG. 15C is a perspective view of the grain loss detector of FIG. 15A. FIG. 15D is a top plan of the grain loss detector of FIG. 15A with the top plate of the enclosed frame 120 removed to show a plurality of cameras 110 and lights 109 disposed around an interior periphery of the enclosed frame 120. The enclosed frame 120 may be rectangular as shown, or other desired shape. The enclosed frame 120 includes outer sidewalls 122, inner sidewalls 124 a top wall 125 and a bottom wall 126 defining an open area 127. A plurality of cameras 110-a, 110-b, 110-c, 110-d are disposed around the interior periphery each with its field of view directed toward the open area 127. Lights 109 may be disposed adjacent to each side of the cameras 110a-110d. The inner sidewalls 124 is preferable made of a transparent material such as acrylic or plexiglass so the lights 109 and cameras 110a-110d are protected from dirt and debris behind the inner sidewalls 124 while still permitting the light to shine into the open area 127 and to capture images of the crop material passing through the open area 127. The ring structure 120 is supported by brackets 113 from the underside of the rear pan 94. It should be appreciated that instead of a plurality of cameras 110a-110d, a single camera or two cameras may be also be used. It should be appreciated that in addition to one or more cameras 110, any of the various types of other sensors 110 described above may also be employed in cooperation with the one or more cameras 110 or in place of the one or more cameras 110 for the grain loss detector 100F.

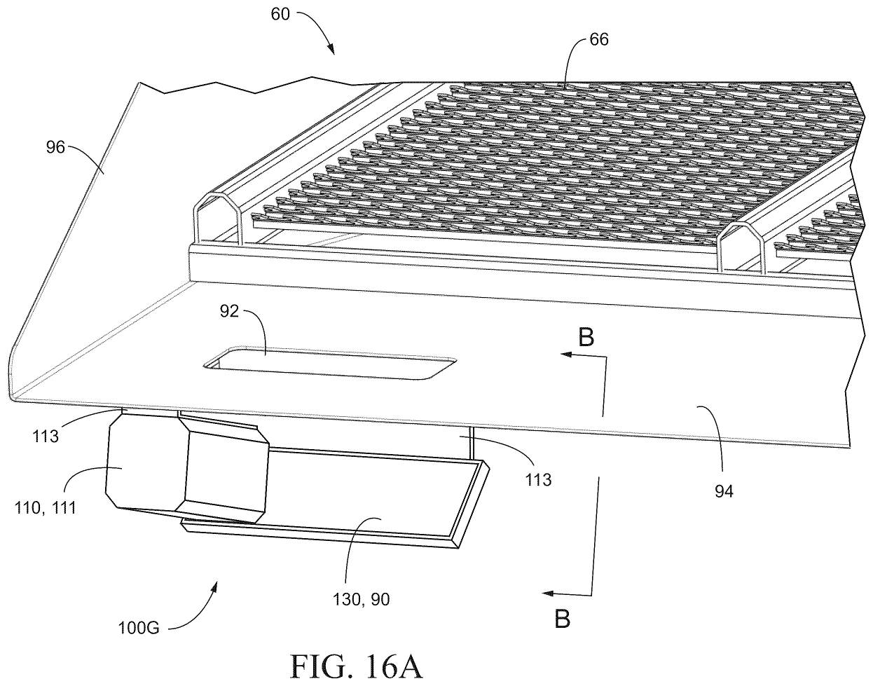

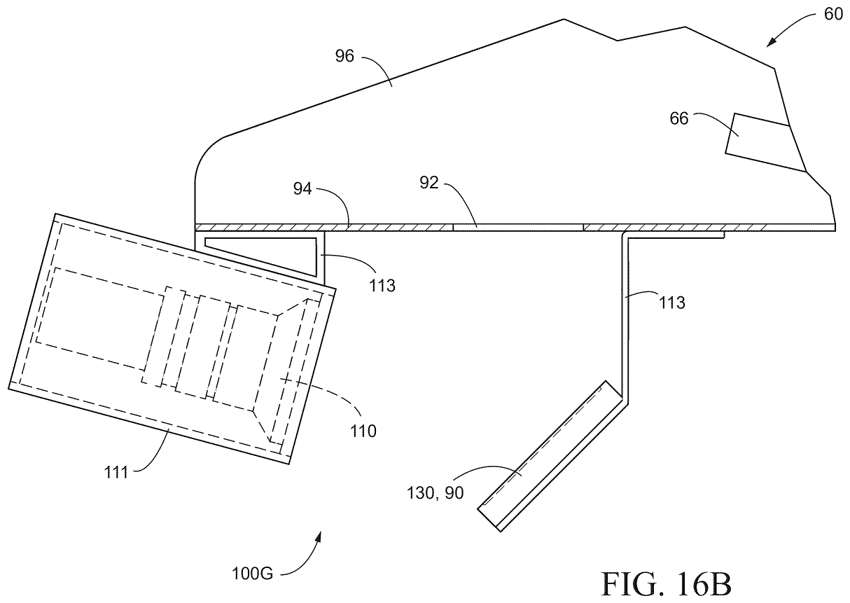

FIG. 16A is a rearward perspective view of another embodiment of a grain loss detector 100G that utilize openings 92 in the rear pan 94. The openings 92 may be cut into the rear pan 94 or the openings 92 may be existing openings remaining after the conventional or prior art sieve loss sensors 90 as shown in FIGS. 13A are removed. FIG. 16B is a side elevation view of the grain loss detector 100G as viewed along lines B-B of FIG. 16A. In this embodiment, the grain loss detector 100G includes a camera 110 disposed within a housing 111 with the camera's field of view directed toward a slide plate 130 disposed at a downwardly, rearwardly sloped angle below the opening 92 in the rear pan 94. Thus, as the crop material passes through the opening 92, the crop material falls onto the slide plate 130 transverse to the camera 110. The slide plate 130 serves to slow the flow of crop material and provides a backdrop to the crop material which may make identification of the grain kernels easier. It should be appreciated that in combines already equipped with sieve sensors 90 disposed at an angle below an existing opening 92 in the rear plate as shown in FIG. 13B, the existing sieve sensors 90 may serve as the slide plate 130. Thus, the existing sieve sensors 90 may remain fully functional while serving the dual purpose as a slide plate 130 for the grain loss detector 100G so the camera 110 may capture images of the crop material passing over the existing sieve sensor 90. Both the camera 110 and the slide plate 130 are supported by brackets 113 below the rear pan 94. Lights 109 (not shown) may be disposed under the rear plate 94 adjacent to the camera 110 to illuminate the slide plate 130 in low light or at night. The surface of the slide plate 130 may have a color that provides a contrasting background for easier identification of the grain kernels against the contrasting background color. Alternatively the slide plate 130 may be backlit which would also provide a contrasting background and which may avoid the need for lights 190 shining on the slide plate 130. As previously discussed, the lights 109 or backlighting of the slide plate 130 may be programmed to turn on and off before and after each digital image is generated, or the lights 109 or backlighting of the slide plate 130 may be programmed to turn on just before the digital images are generated and to stay on for a programmable duration. Alternatively, the lights 109 or backlighting of the slide plate 130 may be always on. It should be appreciated that in addition to the camera 110, any of the various types of other sensors 110 described above may also be employed in cooperation with the camera 110 or in place of the camera 110 for the grain loss detector 100G.

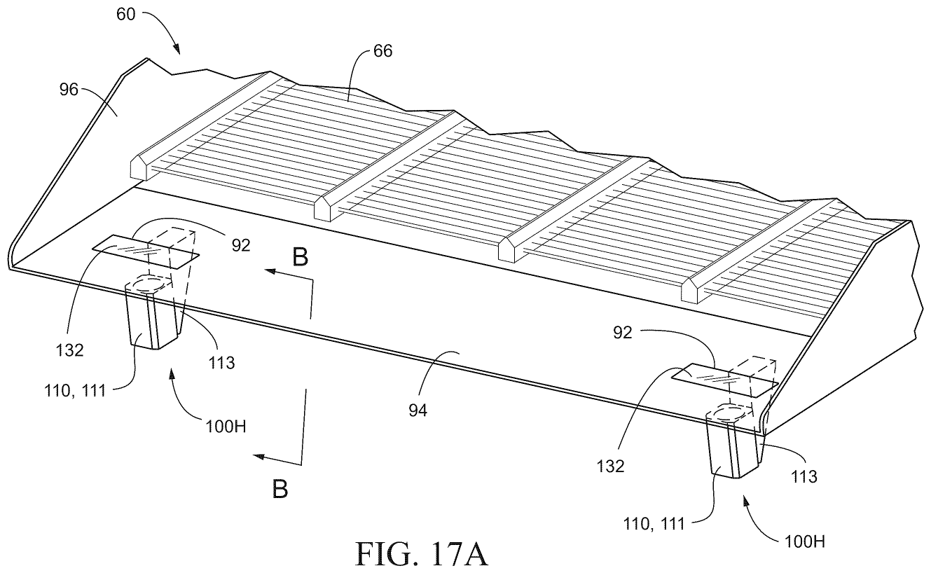

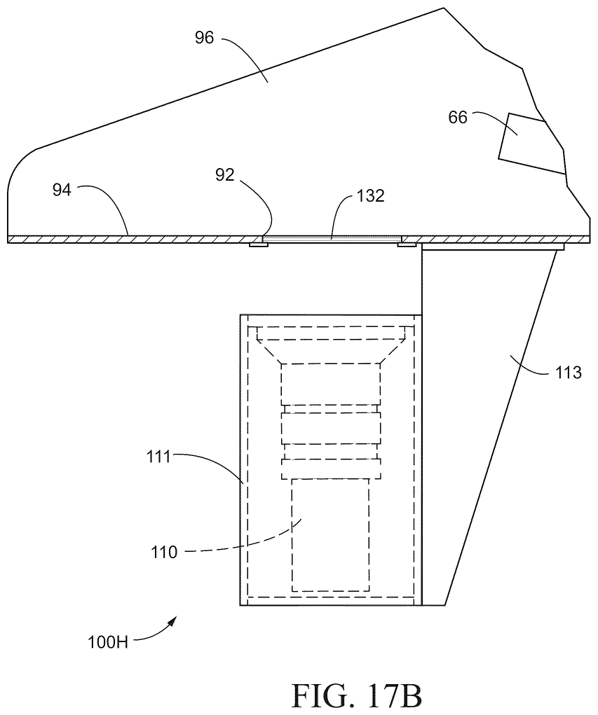

FIG. 17A is a rearward perspective view of another embodiment of a grain loss detector 100H that utilize openings 92 in the rear pan 94. The openings 92 may be cut into the rear pan 94 or the openings 92 may be existing openings remaining after the conventional or prior art sieve loss sensors 90 as shown in FIGS. 13A or 13B are removed. FIG. 17B is a side elevation view of the grain loss detector 100H as viewed along lines B-B of FIG. 17A. In this embodiment, the grain loss detector 100H includes a camera 110 supported below the rear plate 94 and under the opening 92 by brackets 113. The opening 92 is covered by a transparent window 132 and the camera 110 is oriented vertically with its field of view toward the window 132. The transparent window 132 may be acrylic, plexiglass or any other suitable material that is substantially transparent and is ideally resistant to scratching, wear and discoloration. In use, the camera 110 captures images from below the window 132 of the crop material passing over the upper surface of the window 132 transverse to the camera 110. Lights 109 (not shown) may be disposed under the rear plate 94 adjacent to the camera 110 to illuminate the window 132 in low light or at night. As previously discussed, the lights 109 may be programmed to turn on and off before and after each digital image is generated, or the lights 109 may be programmed to turn on just before the digital images are generated and to stay on for a programmable duration. Alternatively, the lights 109 may be always on. It should be appreciated that in addition to the camera 110, any of the various types of other sensors 110 described above may also be employed in cooperation with the camera 110 or in place of the camera 110 for the grain loss detector 100H.

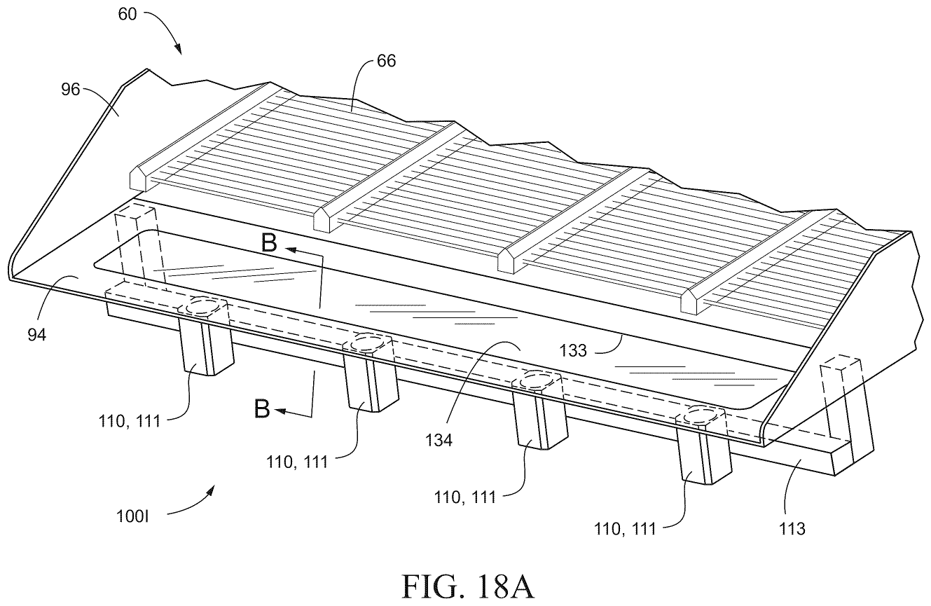

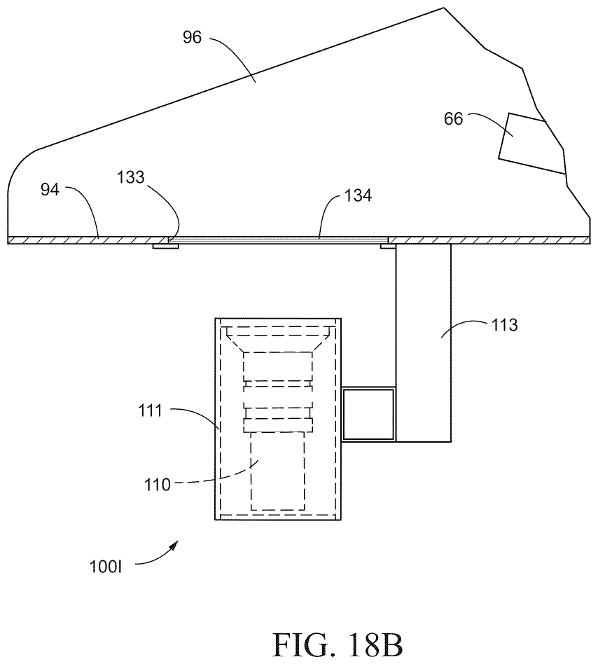

FIG. 18A is a rearward perspective view of another embodiment of a grain loss detector 100I. FIG. 18B is a side elevation view of the grain loss detector 1001 as viewed along lines B-B of FIG. 18A. In this embodiment, the rear pan 94 of the cleaning shoe 60 is modified to incorporate a large transparent window 134 covering an opening 133 extending substantially the width of the rear pan 94. A plurality of cameras 110 are spaced across the width of the upper sieve 66 and supported by a bracket or frame 113 below the window 134 on the underside of the rear pan 94. Each of the plurality of cameras 110 is oriented vertically with its field of view upward toward the window 134 such that the cameras are transverse to the direction of flow of the crop material passing over the rear pan 94 and transparent window 134. Each of the cameras 110 may be disposed in a housing 111 to protect the camera from dirt and debris. The transparent window 134 may be acrylic, plexiglass or any other suitable material that is substantially transparent and is ideally resistant to scratching, wear and discoloration. In use, the plurality of cameras 110 capture images from below the window 134 of the crop material passing over the upper surface of the window 134. Lights 109 (not shown) may be supported from the bracket or frame 113 under the rear plate 94 adjacent to the cameras 110 to illuminate the window 134 in low light or at night. As previously discussed, the lights 109 may be programmed to turn on and off before and after each digital image is generated, or the lights 109 may be programmed to turn on just before the digital images are generated and to stay on for a programmable duration. Alternatively, the lights 109 may be always on. It should be appreciated that the grain loss detector 1001 provides a large surface area extending substantially across the width of the rear pan 94 with which to identify any grain kernels within the crop material discharged from the upper sieve 66 compared to the prior art sieve loss sensors 90 which utilize comparatively small sensors disposed only at the outer ends of the rear pan 94 as shown in FIGS. 13A and 13B. Similarly, the grain loss detector 1001 provides a larger surface area with more cameras 110 with which to identify any grain kernels within the crop material discharged from the upper sieve 66 compared to the previously described grain loss detector embodiments 100E-100H which utilize smaller openings 92 in the rear pan. It should be appreciated that in addition to the cameras 110, any of the various types of other sensors 110 described above may also be employed in cooperation with the cameras 110 or in place of the cameras 110 for the grain loss detector 100I.

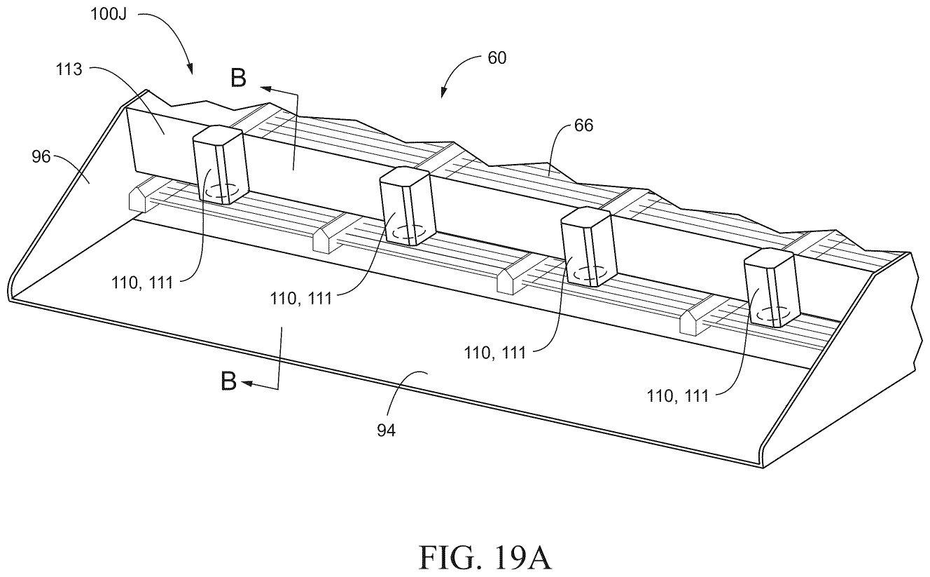

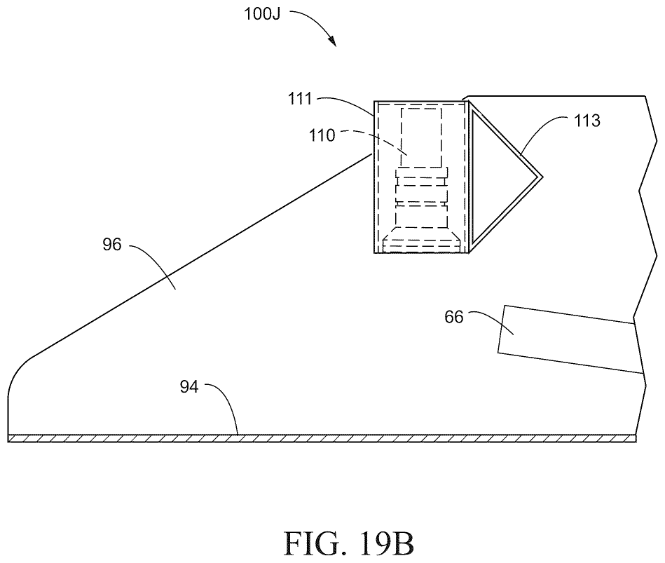

FIG. 19A is a rearward perspective view of another embodiment of a grain loss detector 100J. FIG. 19B is a side elevation view of the grain loss detector 1001 as viewed along lines B-B of FIG. 19A. In this embodiment, the grain loss detector 100J includes a plurality of cameras 110 spaced across the width of the upper sieve 66 and supported by a bracket or frame 113 above the rear pan 94. Each of the plurality of cameras 110 is oriented vertically with its field of view downward toward the rear pan 94 such that the cameras 110 are transverse to the direction of flow of the crop material across the rear pan 94. Each of the cameras 110 may be disposed in a housing 111 to protect the camera from dirt and debris. In use, the plurality of cameras 110 capture images of the crop material passing over the upper surface of the rear pan. The upper surface of the rear pan 94 may have a color that provides a contrasting background for easier identification of the grain kernels against the contrasting background color. As best viewed in FIG. 19B, the bracket or frame 113 extending across the width of the cleaning shoe 60 is illustrated as having a triangular shape to minimize buildup of crop material on the frame 113 and to facilitate the crop material passing under the frame 113. Lights 109 (not shown) may be disposed on the bracket of frame 113 above the rear pan 94 adjacent to the cameras 110 to illuminate the rear pan 94 in low light or at night. As previously discussed, the lights 109 may be programmed to turn on and off before and after each digital image is generated, or the lights 109 may be programmed to turn on just before the digital images are generated and to stay on for a programmable duration. Alternatively, the lights 109 may be always on. It should be appreciated that in addition to the cameras 110, any of the various types of other sensors 110 described above may also be employed in cooperation with the cameras 110 or in place of the cameras 110 for the grain loss detector 100J.

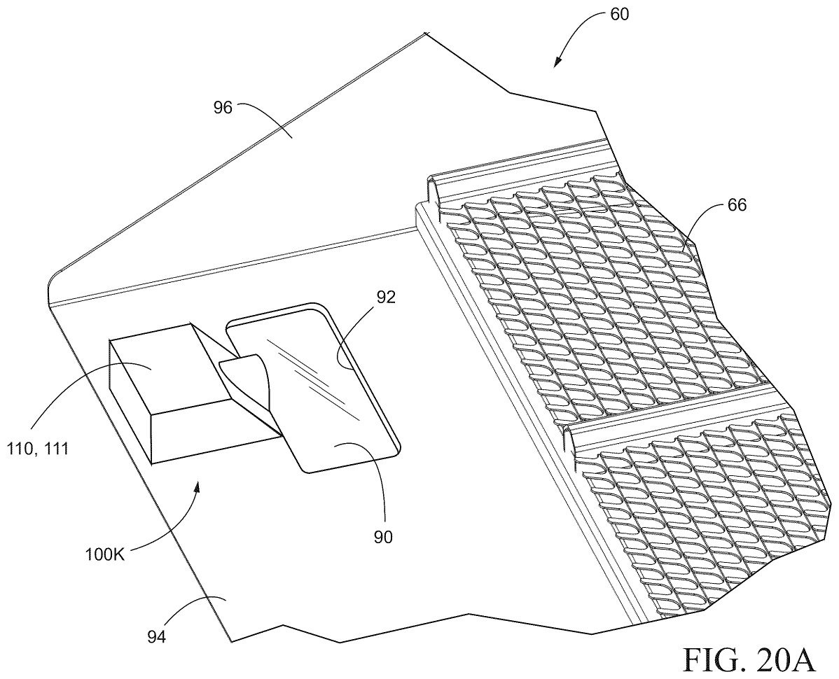

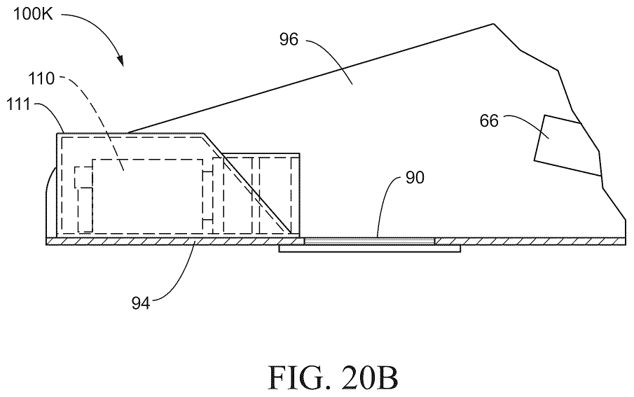

FIG. 20A is a rearward perspective view of another embodiment of a grain loss detector 100K. FIG. 20B is a side elevation view of the grain loss detector 100K as viewed along lines B-B of FIG. 20A. In this embodiment, the grain loss detector 100k includes at least one camera 110 disposed on the upper surface of the rear pan 94 or spaced a distance above the rear pan 94 with its field of view directed toward the upper sieve 66 such that the camera is oriented toward the direction of flow of the crop material over the rear pan 94. In FIG. 20A, the camera 110 is shown disposed rearward of each of the existing sieve loss sensors 90. Alternatively, the existing sieve loss sensor 90 may be removed resulting in an opening 92 forward of the camera 110. In still other embodiments the opening 92 may be cut into the rear pan 94 forward of the camera 110. It should also be appreciated that the at least one camera 110 may be a single camera 110 disposed at or near the center of the rear pan 94 or anywhere across the width of the rear pan 94, or the at least one camera 110 may include a plurality of cameras 110 which may be spaced across the width of the rear pan 94 with or without openings 92 forward of the cameras 110. In use, the at least one camera 110 captures images of the crop material discharged from the upper sieve 66. In embodiments incorporating an opening 92 forward of the camera 110, the camera 110 may be positioned at a declining angle to capture images of the crop material as it falls through the opening 92 transverse to the camera 110. The at least one camera 110 may be disposed in a housing 111 to protect the camera from dirt and debris. As best viewed in FIG. 20B, the forward end of the housing 111 is sloped to minimize buildup of crop material in front of the housing 111 and to facilitate the crop material passing over the housing 111. Lights 109 (not shown) may be disposed within the housing 111 adjacent to the camera 110 to illuminate the rear end of the upper sieve 66 in low light or at night. As previously discussed, the lights 109 may be programmed to turn on and off before and after each digital image is generated, or the lights 109 may be programmed to turn on just before the digital images are generated and to stay on for a programmable duration. Alternatively, the lights 109 may be always on. It should be appreciated that in combines equipped with existing sieve loss sensors 90 as shown in FIGS. 13A or 13B, the sieve sensors 90 may remain in place as shown in FIGS. 20A and 20B and may remain fully functional. It should be appreciated that in addition to the at least one camera 110, any of the various types of other sensors 110 described above may also be employed in cooperation with the at least one camera 110 or in place of the at least one camera 110 for the grain loss detector 100K.

It should be appreciated that each of the various embodiments of the grain loss detectors 100A-100K may be used in conjunction with any of the combine's other original equipment grain loss sensors as a double check to determine the accuracy of each. Additionally, or alternatively, the grain loss detector 100 may be used in conjunction with a drop pan system such as the Bushel Plus® harvest loss system which collects a physical sample of crop material within one or more drop pans or trays that are dropped from the combine to the ground surface while harvesting, as more fully described in U.S. Pat. Nos. 10,932,411 and 10,945,369 and in PCT Publication No. WO2021/183837, each of which is incorporated herein by reference. The grain loss measurement from the Bushel Plus harvest loss system can then be compared with the grain loss measurement of any of the grain loss detector embodiments 100A-100K (collectively and individually, grain loss detector 100) as a check on the accuracy of the grain loss detector 100.

The foregoing description and drawings are intended to be illustrative and not restrictive. Various modifications to the embodiments and to the general principles and features of the grain loss detector, systems and methods described herein will be apparent to those of skill in the art. Thus, the disclosure should be accorded the widest scope consistent with the appended claims and the full scope of the equivalents to which such claims are entitled.

1. A grain loss detector for a combine harvester having threshing stage components, separating stage components, and cleaning stage components, the grain loss detector comprising:
at least one camera positioned and configured to capture digital image frames of crop material that is discharged from an end of a separating stage component or cleaning stage component of the combine harvester while harvesting a crop, the discharged crop material containing grain kernels and material other than grain (MOG);
a computing device in data communication with the at least one camera to receive the digital image frames, the computing device including memory for storing the received digital image frames and software configured to process the received digital image frames to identify the grain kernels from among the MOG within the received digital image frames based on crop data characteristics associated with the crop being harvested, the crop data characteristics including any of: color characteristics of the grain kernels of the crop, shape characteristics of the grain kernels of the crop, and size characteristics of the grain kernels of the crop.

2. The grain loss detector of claim 1, wherein the crop data characteristics include historical digital image frames of the crop being harvested against which the software compares the received digital image frames to identify the grain kernels of the crop from the MOG.

3. The grain loss detector of any of claim 1, wherein the separating stage components include at least a separating concave and wherein the cleaning stage components include any of an upper sieve, a lower sieve and a straw walker.

4. The grain loss detector of any of claim 1, further comprising a collector mounted to receive a portion of the discharged crop material from any one of the separating stage components and the cleaning stage components, the collector having an inlet end, an outlet end and a channel extending between the inlet end and the outlet end, the inlet end directing the portion of the discharged crop material into the channel, wherein the at least one camera is disposed transverse to a direction of flow of the portion of the discharged crop material passing through the channel.

5. The grain loss detector of any of claim 1, wherein the combine harvester includes a rear pan over which the discharged crop material passes, the rear pan including a rear pan opening through which a portion of the discharged crop material falls, wherein the at least one camera is supported below the rear pan opening and wherein the at least one camera is oriented transverse to a direction of flow of the portion of the discharged crop material falling through the rear pan opening.

6. The grain loss detector of claim 5, further comprising a slide plate disposed below and transverse to the rear pan opening such that the portion of the discharged crop material falling through the rear pan opening slides over an upper surface of the slide plate and wherein the at least one camera is oriented transverse to the upper surface of the slide plate.

7. The grain loss detector of claim 5, further comprising a frame enclosure disposed below the rear pan opening, the frame enclosure having an interior perimeter defining an open area disposed below the rear pan opening, wherein the at least one camera comprises a plurality of cameras disposed around the interior perimeter, and wherein each of the plurality of cameras is oriented toward the open area such that each of the plurality of cameras is transverse to the direction of flow of the portion of the discharged crop material passing through the rear pan opening and through the open area of the frame below the rear pan opening.

8. The grain loss detector of claim 5, wherein the combine harvester includes a rear pan over which the discharged crop material passes, the rear pan including a rear pan opening covered by a transparent window such that a portion of the discharged crop material passes in a direction over the transparent window, wherein the at least one camera is supported below the transparent window and wherein the at least one camera is oriented toward the transparent window.

9. The grain loss detector of claim 8, wherein the transparent window has a width proximate a width of the rear pan, and wherein the at least one camera comprises a plurality of cameras spaced below the transparent window.

10. The grain loss detector of claim 1, wherein the combine harvester includes a rear pan having a width over which the discharged crop material passes in a direction of flow, and wherein the at least one camera comprises a plurality of cameras supported above the rear pan and spaced across the width of the rear pan, and wherein each of the plurality of cameras is oriented transverse to the direction of flow of a portion of the discharged crop material passing over the rear pan.

11. The grain loss detector of any of claim 1, wherein the combine harvester includes a rear pan over which the discharged crop material passes in a direction of flow, wherein the camera is supported on an upper surface of the rear pan or above the upper surface of the rear pan and the at least one camera is oriented in a direction toward the direction of flow of a portion of the discharged crop material passing over the rear pan.

12. The grain loss detector of claim 4, further comprising a light disposed to illuminate the portion of the discharged crop material when the digital image frames are being captured by the at least one camera.

13. The grain loss detector of claim 1, wherein the software is configured to selectively display the received digital image frames.

14. The grain loss detector of claim 1, wherein the software is further configured to quantify the identified grain kernels within sequential ones of the received digital image frames over a time period to determine a grain loss amount.

15. The grain loss detector of claim 14, wherein the software is further configured to display the grain loss amount as a ratio of predefined units of yield loss.

16. The grain loss detector of claim 15, wherein the software is further configured to display the grain loss amount in terms of an economic loss amount.

17. The grain loss detector of claim 14, wherein the software is further configured to trigger a warning if the grain loss amount exceeds a preselected threshold, wherein the warning may be a visual warning or an audible warning.

18. The grain loss detector of claim 14, wherein the software is further configured to display recommended corrective actions to optimize operating parameters of at least one of the threshing stage components, separating stage components or cleaning stage components if the grain loss amount exceeds a preselected threshold.

19. The grain loss detector of claim 14, wherein operating parameters of at least one of the threshing stage components, the separating stage components and the cleaning stage components are electronically controllable by a CAN bus and wherein the software is configured to interface with the CAN bus to automatically adjust the at least one of the threshing stage components, the separating stage components and the cleaning stage components if the grain loss amount exceeds a preselected threshold.

20. The grain loss detector of claim 1, further including other sensors in data communication with the computing device and interfacing with the software, wherein the other sensors are configured to generate sensor data indicative of other characteristics of the discharged crop material passing the other sensors, including any of: velocity, density, size, shape and dielectric constants.
